(19) United States
(12) Patent Application Publication
(10) Pub. No.: US 2026/0004365 A1
(43) Pub. Date: Jan. 1, 2026

(54) AUTOMATIC IDENTIFICATION OF CAUSAL INFLUENCES AND INFLUENTIAL AGENTS IN SOCIAL NETWORKS

(71) Applicant: ECOLE POLYTECHNIQUE FEDERALE DE LAUSANNE (EPFL), Lausanne (CH)

(72) Inventors: Mert Kayaalp, ST-SULPICE VD (CH); Ali Sayed, ST-SULPICE VD (CH)

(73) Assignee: ECOLE POLYTECHNIQUE FEDERALE DE LAUSANNE (EPFL), Lausanne (CH)

(21) Appl. No.: 18/758,966

(22) Filed: Jun. 28, 2024

(51) Int. Cl. G06Q 50/00

(52) U.S. Cl. CPC G06Q 50/01

(57) ABSTRACT

Systems, methods and apparatus for detecting and assessing influence within a social network that treat influence as a causal quantity and approach this task from the perspective of structural causal models.

### FIELD OF THE INVENTION

The invention relates to the field of influence estimation within social networks.

### BACKGROUND

Identifying influential agents in a social media network is a crucial problem with wide-ranging applications, such as detecting propaganda-sharing accounts or selecting individuals for targeted advertisement. However, over any social network or social media network (i.e., computer-implemented systems that facilitate the creation and sharing of information, ideas, career interests and other forms of expression via virtual communities), information transmitted therethrough usually spreads and mixes, leading to ripple effects that make the discovery of influence rather challenging. For example, the information leaving a source agent may be altered and combined with comments/data from other agents along the path until it reaches its destination.

It is known to measure social network influence through some network topology-based properties such as the eigenvector centrality of an agent, or through some descriptive importance factor depending on the problem at hand.

### SUMMARY

Various deficiencies in the prior art are addressed below by methods and systems for detecting and assessing influence within a social network that treat influence as a causal quantity and approach this task from the perspective of structural causal models. More specifically, influence is defined in terms of the change in behavior of the network when real or hypothetical interventions occur at or by individual agents within the network (e.g., injection of new or existing content or opinion or other information into the network). This is a useful method to discard spurious and non-causal associations, unlike other methods based, for example, on the use of Granger causality. While conducting interventional experiments is not feasible over real world social networks, the efficacy of various embodiments will be assessed via raw observational data and appropriate representative models.

For example, in one embodiment a system for detection and quantification of influence comprises: a data extraction processor configured to sample data from one or more social networks; a sentiment analysis processor configured to: receive sampled data from the data extraction processor, the received sampled data including social media interactions associated with each of a plurality of users; and determine, via a sentiment quantification mechanism, for each of at least a portion of the social medial interactions of the plurality of users, a respective sentiment score indicative of user sentiment associated with a topic of interest at a time of social media interaction; an opinion formation model learning processor configured to fit an opinion propagation model to changes in user sentiment scores associated with temporally ordered sequences of social media interactions; a causal inference processor configured to determine causal influences associated with changes in user sentiment scores of the opinion propagation model; and a multidimensional array construction processor configured to generate a bipartite user influence matrix. The sentiment quantification mechanism may be implemented via a neural network. The influence ranking processor may be configured to order influential users by rank for each of at least one topic of interest in accordance with one of average influence ranking and causal ranking, and further configured to assign importance indicative weights to targeted users or user groups.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWING

The teachings herein can be readily understood by considering the following detailed description in conjunction with the accompanying drawings, in which:

FIG. 1 depicts a high-level block diagram of a system suitable for use in implementing the various embodiments;

FIGS. 2A-2C illustrate inherent challenges in estimating the causal influence of one agent on another;

FIG. 3 illustrates a strongly connected network topology.

FIG. 4 illustrates an atomic and persistent intervention on an agent m=1 such as shown in FIG. 3;

FIG. 5 illustrates a fully connected network topology;

FIG. 6 illustrates a federated architecture;

FIG. 7 illustrates a unidirectional ring;

FIG. 8 illustrates a CausalRank method according to an embodiment;

FIG. 9 illustrates a GraphCausalityLearning (GCL) method according to an embodiment;

FIG. 10 depicts a flow diagram of a method according to various embodiments suitable for use with the system of FIG. 1;

FIG. 11 illustrates a graph topology of a strongly connected network architecture used in a simulation of various embodiments;

FIGS. 12A-12B illustrate bipartite causal influence matrix and combination matrix, respectively, corresponding to the network topology of FIG. 11 and formed with averaging rule.

FIG. 13 illustrates a ranking of agents based on their causal influence (for both CausalRank and AIR) and their network-topology based eigenvector centrality;

FIG. 14 illustrates an average influence on agent k=4 from its neighborhood of 1,2 and 3 hop distances with respect to changing values of forgetting factor S;

FIG. 15 illustrates causal influence estimation error with respect to increasing number of time samples M;

FIG. 16 illustrates correlation and causation between agents 6 and 11 of the network of FIG. 11 with respect to varying dependence between the streaming observations they receive.

FIG. 17 illustrates a sampled Twitter sub-network;

FIG. 18 illustrates sample tweets from the users in the sub-network topology of FIG. 17. The number on the upper right hand side quantifies the positive attitude towards Bitcoin;

FIG. 19A-19B illustrate, respectively, a bipartite causal influence matrix and an adjacency matrix corresponding to the sub-network topology of FIG. 17; and

FIG. 20 illustrates ranking of agents based on their causal influence and their corresponding network eigenvector centrality. Both ranking scores are summing up to one.

To facilitate understanding, identical reference numerals have been used, where possible, to designate identical elements that are common to the figures.

### DETAILED DESCRIPTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It must be noted that as used herein and in the appended claims, the singular forms “a”, “an”, and “the” include plural referents unless the context clearly dictates otherwise.

The various embodiments disclosed and described herein for detecting and assessing influence within a social network treat influence as a causal quantity and approach this task from the perspective of structural causal models. More specifically, influence is defined in terms of the change in behavior of the network when real or hypothetical interventions occur at or by individual agents within the network (e.g., injection of new or existing content or opinion or other information into the network). This is a useful method to discard spurious and non-causal associations, unlike other methods based, for example, on the use of Granger causality. While conducting interventional experiments is not feasible over real world social networks, the efficacy of various embodiments will be assessed via raw observational data and appropriate representative models.

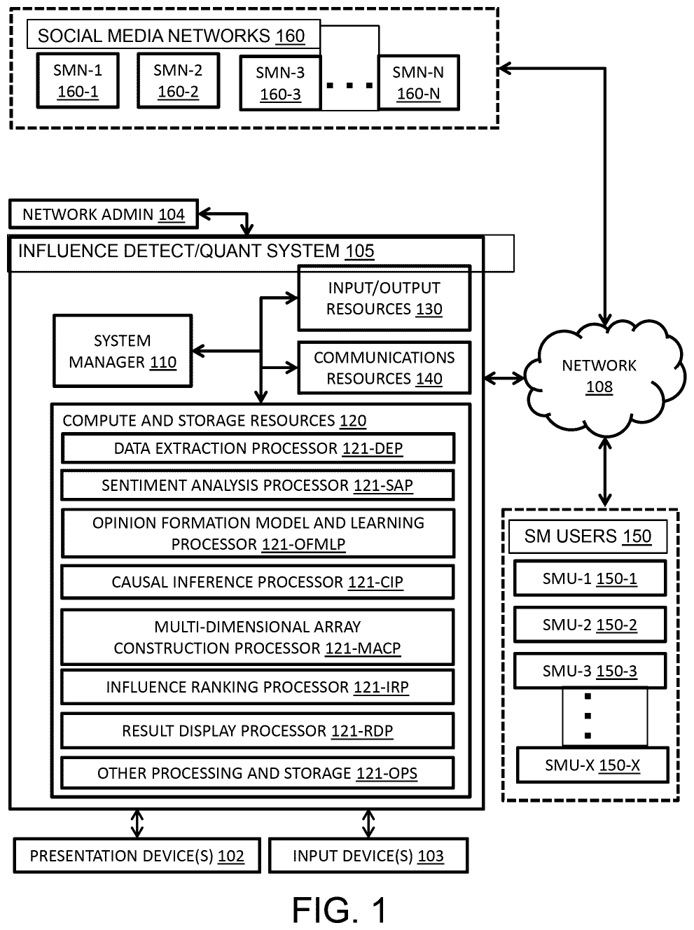

FIG. 1 depicts a high-level block diagram of an influence detection and quantification system according to various embodiments.

The influence detection and quantification system 105 of FIG. 1 comprises one or more data processing elements, computing devices, network elements and the like cooperating as described herein to implement various embodiments. Not all of the described data processing elements, computing devices, network elements and the like are necessary to implement each embodiment. The exemplary system described herein is provided for illustrative purposes only. The system 500 of FIG. 1 may be implemented via one or more servers, workstations, data centers and/or other computing and memory providing devices operating in accordance with the various embodiments, such as described herein and with respect to the various other figures.

In various embodiments, the influence detection and quantification system 105 of FIG. 1 is implemented within the context of one or more data centers having instantiated therein compute and memory/storage resources configured in accordance with the embodiments described herein.

As shown in FIG. 1, the influence detection and quantification system 105 is depicted as comprising a system manager 110, compute (processing) and storage (memory) resources 120, input/output resources 130, and communications resources 140. Generally speaking, the system manager 110 may be used to control various aspects of the system 105 such as the configuration or operational control of the individual elements of the system 105, the managing of resources within the system 105, and so on. In various embodiments a system manager 110 is not used (i.e., the individual elements are configured for operation without the use of a local system manager 110).

The input/output (I/O) resources or interface(s) 130 are configured to enable communication between the system 105 and various presentation devices 102 and/or input devices 103. For example, the I/O resources or interface(s) 130 may be coupled to one or more presentation devices (PDs) 102 such as associated with display devices for presenting information to a user, one or more input devices (IDs) 103 such as touch screen or keypad input devices for enabling user input, and/or interfaces enabling communication between the system 105 and other computing, networking, presentation or input/output devices (not shown).

Presentation devices 102 may include a display screen, a projector, a printer, one or more speakers, and the like, which may be used for displaying data, displaying video, playing audio, and the like, as well as various combinations thereof, an application programming interface (API) configured to support the presentation of data, and so on. The typical presentation interfaces associated with user devices, including the design and operation of such interfaces, will be understood by one skilled in the art.

Input devices (ID) 103 may include any user control devices suitable for use in enabling a local or remote user of the system 105 to interact with the system 105. For example, the input devices 103 may include touch screen based user controls, stylus-based user controls, a keyboard and/or mouse, voice-based user controls, and the like, as well as various combinations thereof. The typical user control interfaces of user devices, including the design and operation of such interfaces, will be understood by one skilled in the art.

Although primarily depicted and described as having specific types and arrangements of components, it will be appreciated that any other suitable types and/or arrangements of components may be used for system 105.

The communications resources 140 are configured to enable communication between the system 105 and a network 108 such as any combination of the internet, edge networks, corporate networks, wired and wireless networks and so on to enable thereby communications between the system 105 and one or more of social media networks (SMNs) or platforms 160; illustratively, social media networks/platforms SMN-1 160-1, SMN-2 160-2, SMN-3 160-3 and so on up to SMN-N 160-N (collectively denoted herein as SMNs 160). It is noted that social media networks 160 may comprise one or more social media platforms. As such, for purposes of this discussion it will be assumed that the term social media network (SMN) should be broadly construed as one or more platforms within a social media network. For example, the social media networks of Meta include the Facebook, Facebook Messenger, Instagram and WhatsApp platforms. Similarly, Alphabet provides various versions of YouTube, Google, and other social networks/platforms. Other networks/platforms include Venmo, WeChat, QQ, QZone, Weibo, Twitter, Tumblr, Telegram, Reddit, Baidu Tieba, LinkedIn, LINE, Snapchat, Pinterest, Viber, VK, as well as other social media networks/platforms.

It is further noted that each of a plurality of users 150 communicates via the network 108 or some other network with one or more of the SMNs or platforms 160, illustratively social media users (SMUs) SMU-1 150-1, SMU-2 150-2, SMU-3 150-3 and so on up to SMU-X 160-X (collectively denoted herein as SMUs 150). Each of the SMUs 150 accesses his or her social media networks or platforms 160 via individual accounts thereon, and via any type of wired or wireless communications device, such as user terminals (e.g., mobile phones, laptops, tablets and the like), fixed wireless access devices (e.g., set top boxes, digital video recorders, stationary computing devices and the like) and/or other types of user devices.

As shown in FIG. 1, the compute and storage resources 120 of the system 105 are used to implement various processors or modules in accordance with the embodiments, including a data extraction processor 121-DEP, a sentiment analysis processor 121-SAP (e.g., a mechanism to quantify strength of opinion of a user toward a particular topic, brand, question, candidate, and so on), an opinion formation model learning processor 121-OFMLP, a causal inference processor 121-CIP, a multidimensional array construction processor 121-MACP (e.g., a two dimension matrix construction processor), an influence ranking processor 121-IRP, a result display processor 121-RDP, and various other processing and storage elements 121-OPS. These processors or modules will be discussed in more detail below.

Generally speaking, in some embodiments the data extraction processor 121-DEP is configured to sample information from one or more social networks; the sentiment analysis processor 121 is configured to receive sampled information from the data extraction processor, the received sampled information including social media interactions associated with each of a plurality of users (e.g., data comprising or indicative of direct or new posts/threads of content, information, questions, and the like; data comprising or indicative of responses to existing posts/threads or portions thereof; data comprising or indicative of agreement/disagreement to existing posts/threads or portions thereof; and/or data comprising or indicative of other user expressions forming a partial or total user footprint of user interactions with the network(s)), and to determine, using a sentiment quantification mechanism (such as a neural network, another machine learning model, or other hardware/software configured to quantify/score opinion or sentiment), for each of at least a portion of the social medial interactions of the plurality of users, a respective sentiment score indicative of user sentiment associated with a topic of interest at a time of social media interaction; the opinion formation model learning processor 121-OFMLP is configured to fit an opinion propagation model to changes in user sentiment scores associated with temporally ordered sequences of social media interactions; the causal inference processor 121-CIP is configured to discard confounding factors from the opinion propagation model; the multidimensional array construction processor 121-MACP is configured to generate a bipartite user influence matrix or array (2D, 3D, or larger matrix/array); the influence ranking processor 121-IRP is configured to order influential users by rank for each of at least one topic of interest such as via average influence ranking or causal ranking; and the result display processor 121-RDP is configured to provide output data to presentation devices and/or other processing elements or systems.

It is noted that the term bipartite as used herein means there exists a causal influence score for each user m on each user k for a plurality of m,k pairs. It is further noted that, while some of the embodiments described herein are symmetrical, the bipartite matrix is not symmetric in general (i.e., the influence of user A on user B is different than the influence of user B on user A).

It is noted that the multidimensional array processor described herein with respect to the illustrative embodiments generally comprises a two-dimension array or matrix construction processor. However, various embodiments also contemplate three-dimension (more generally n-dimension) arrays or matrices. As such, the various equations, algorithms, methods, and so on described herein may be adapted to three-dimension arrays or matrices.

Various elements or portions thereof depicted in FIG. 1 and having functions described herein are implemented at least in part as computing devices having communications capabilities, including in support of the SMUs 160, SMNs 160, network 108, system 105, and so on. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using network equipment used to implement network functions at a network core, network equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The network equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

The embodiments described herein benefit from various models for social learning over graphs. These models are widely used to model opinion formation from a behavioral perspective, and their generalization to real-world scenarios is verified by field experiments. From an engineering perspective, the models can be utilized to design distributed decision-making systems where a group of agents (e.g., robots, sensors) collaboratively make decisions about the environment. However, most of the research on social learning models has focused on analyzing their convergence and error behavior under different assumptions, such as verifying whether truth learning occurs in the presence of malicious agents supplying misinformation, or whether the models can track drifts in the underlying hypothesis. In contrast, the embodiments provided herein by the inventors utilize opinion formation models to examine causal effects over social graphs, which advantageously addresses the diffusion of influence over a graph from a causal inference perspective.

### 1.1 Contributions

Sec. 4 discloses novel causal impact criterion for dynamic social networks in Sec. 4. It quantifies how much an agent m affects another agent k for each agent pair (m,k). Closed-form expressions for these impact factors are disclosed in Secs. 5.1 and 5.2 for both non-Bayesian social learning and adaptive social learning models. Also disclosed is an analysis of useful special cases to illustrate how the causal effects depend on the models.

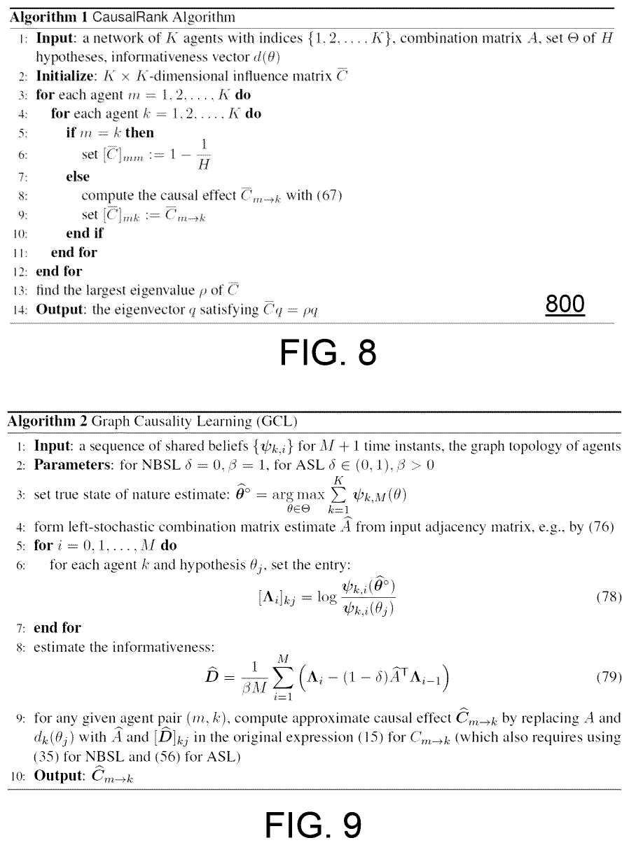

Sec. 6 discloses a CausalRank method (Algorithm 1 of FIG. 8) to rank agents based on their overall influence on the network, while accounting for the fact that more impactful agents should be weighted more. This method is based on the eigenvector centrality of the bipartite causal relations matrix introduced in Sec. 4.

Sec. 7 discloses a graph causality learning (GCL) method (Algorithm 2 of FIG. 9) which allows estimating causal influences from observational data, and in Sec. 8, verification of results with synthetic data.

Sec. 9 illustrates the application of the results to real Twitter data, demonstrating their practical usefulness.

### 1.2 Challenges for Estimating Influence Over Social Networks

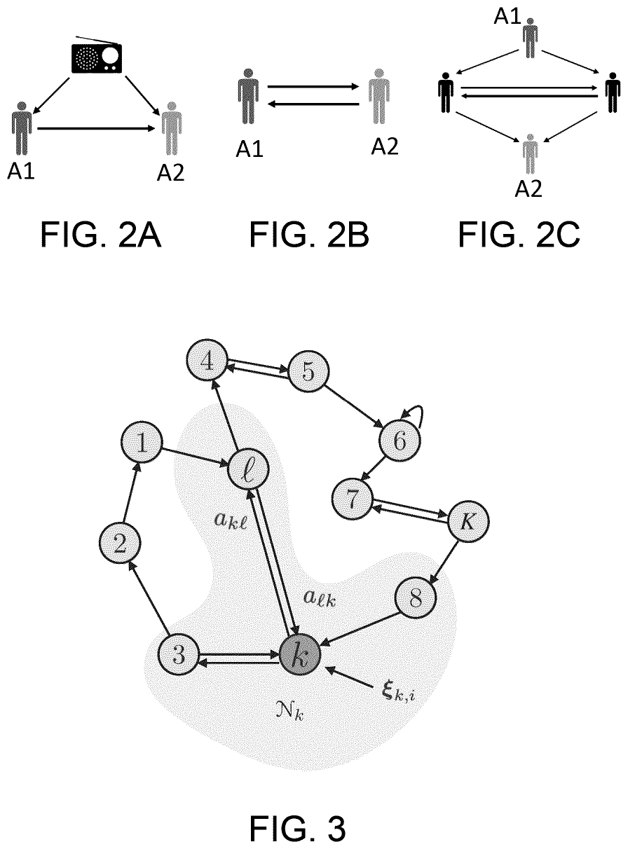

FIGS. 2A-2C illustrate inherent challenges in estimating the causal influence of one agent on another, represented by the first and second agents, respectively. As shown in FIG. 2A, there can be confounding factors that influence both parties and induce non-causal correlation. As shown in FIG. 2B, relationships within social networks are often bidirectional that are not instantaneous, but rather spread out over time. As shown in FIG. 2C, information transmitted from the source is processed and potentially changed along the way.

Influence estimation over social networks faces several challenges, such as:

Confounding factors. Understanding influence requires disentangling correlation from causation. For example, over a social network, it is often observed that individuals who are connected tend to have similar (correlated) opinions. However, this does not necessarily imply a causal relationship and there can also exist confounding factors. For instance, individuals may obtain information from similar external sources (say, the same TV channels), or they may be connected to others who share similar preferences (a.k.a. homophily) see FIG. 2A. Similar issues arise in distributed decision-making systems, such as networks of wireless sensors or robots. Devices that communicate with each other are often in spatial proximity, leading to correlated observations. Therefore, accounting for these confounding factors is crucial for discovering true causal relationships.

Temporal dynamics. Social influence is not a one-time occurrence but rather a continuous process that unfolds over time. Therefore, the inventors adopt a time-series approach to capture this dynamic nature. Unlike traditional models in the literature based on directed acyclic graphs, the inventors accommodate both cyclic networks and bidirectional links to capture feedback mechanisms see FIG. 2B. Doing so is necessary in order to discover the propagation of influence over both space and time.

Mixing and diffusion of information. When examining the influence of an agent m on another agent k, it is essential to acknowledge that information leaving agent m can undergo alterations and become intertwined with the opinions of other agents in the network before reaching agent k see FIG. 2C. This phenomenon introduces additional complexity to the study of influence propagation over graphs.

In this work, the social network models considered allow treating these challenges together in some detail. By employing a rigorous causal theoretical framework, the inventors derive expressions for quantifying social influences within the network while accounting for these challenges.

With respect to notation, in the following discussion random variables are denoted in bold, e.g., x. A sequence of random variables {xᵢ} over index i converging to a random variable x in distribution is denoted by

$${x}_{i} {\to }^{dist .} x .$$

Almost sure convergence is denoted by

$${x}_{i} {\to }^{a . s .} x .$$

The k-th entry of a vector v is denoted by vₖ or [v]ₖ. Denote the all-ones vector of dimension K×1 by 1_{K}. For distributions p₁ and p₂, D_{KL}(p₁∥p₂) denotes their KL divergence.

### 3 Social Learning

### 3.1 Problem Setting

Consider a network of K agents that are trying to infer the hypothesis that best explains their observations about the world. More formally, agents are trying to learn the true state of nature θ°∈Θ from a finite set of H hypotheses, Θ={θ₁, θ₂, . . . θ_{H}}. At each time instant i, each agent k receives a personal and partially informative observation ξ_{k,i}, which encapsulates all out-of-network information available to k at time i and is distributed according to some marginal likelihood function Lₖ(ξ|θ°) dependent on the true state. The observations ξ_{k,i} are assumed i.i.d. over time, but not necessarily across the agents. Since spatial independence is not required, the setting does not exclude possible latent confounders in the observation model. Each agent k knows the likelihood model Lₖ(ξ|θ) for every possible hypothesis θ∈Θ. If the distribution Lₖ(ξ|θ) for a hypothesis θ≠θ° is sufficiently different from Lₖ(ξ|θ°), then it is easier for agent k to distinguish θ° from θ. This “distinguishing power” can be quantified using the KL divergence between the likelihood models, namely,

$${d}_{k} ( θ ) {=}^{Δ} {D}_{KL} ( {L}_{k} ( \cdot \vert {θ}^{∘} ) ‖ {L}_{k} ( \cdot \vert θ ) ) . \qquad ( 1 )$$

The larger this quantity is, the more informative agent k's observations are for distinguishing a wrong hypothesis θ from the true hypothesis θ°. In order to avoid pathological cases, assume that dₖ(θ)<∞ for each agent k and hypothesis θ. This condition makes sure that the likelihood functions for different hypotheses share the same support; and no observation alone is sufficient to refute any hypothesis.

Definition 1 (Global identifiability) For each wrong hypothesis θ≠θ°, if there exists at least one clear-sighted agent k* that can distinguish θ from the true hypothesis θ°, i.e., dₖ* (θ)>0, then the true state of the environment is said to be globally identifiable.

Notice that global identifiability does not require local identifiability, which is the ability of each individual agent to distinguish θ° from any other hypothesis without cooperation with the other agents.

Based on the local observations and on interactions with other agents, each agent k forms an opinion (i.e., a belief vector), denoted by μp_{k,i} which is a probability mass function defined over the set of hypotheses Θ. Here, the entry μ_{k,i} (θ) quantifies the confidence k has about θ∈Θ being the true hypothesis θ° at time i. Assume that all agents have positive initial beliefs and they do not reject any hypothesis at the start of the learning process, i.e., μ_{k,0}(θ)>0 for each agent k and θ∈Θ. Agents exchange their beliefs with each other according to the communication topology described next.

### 3.2 Network TOPOLOGY

FIG. 3 illustrates a strongly connected network topology. For ease of presentation of the embodiments described herein, the various embodiments will be primarily described within the context of a strongly connected network topology. However, the various embodiments are applicable to any network topology, not just a strongly connected network topology.

Specifically, a strongly connected network is where there exists a path linking any agent [symbol] to any other agent k, which starts at [symbol] and ends at k. Moreover, there should exist at least one agent k° with a self-loop, i.e., an agent that does not discard its own observations. The entry [symbol] of the combination matrix A=[ [symbol] ] denotes the confidence score that agent k assigns to the information received from agent [symbol] . This score is positive if, and only if, [symbol] ∈ [symbol] , i.e., agent [symbol] is in the neighborhood of agent k. Otherwise, it is equal to zero. The graph underlying the network is directed and hence the combination matrix A is not necessarily symmetric, i.e., in general [symbol] ≠ [symbol] . Nevertheless, the confidence scores that an agent assigns to its neighbors should add up to one. This means that the matrix A is left-stochastic, and in view of the Perron-Frobenius theorem, it satisfies

$${A}^{T} {1}_{K} = {1}_{K} , {1}_{K}^{T} v = 1 , Av = v , \qquad ( 2 )$$

where v is called the Perron vector of A whose entries are all positive and add up to one. Here, the k-th entry of the vector v measures the relative centrality of agent k in the network.

### 3.3 Non-Bayesian Social Learning (NBSL)

This section presents a non-Bayesian social learning (NBSL) strategy in which, based on the observation ξ_{k,i} at time instant i, each agent first updates its belief in a locally Bayesian fashion to obtain its intermediate belief:

$${ψ}_{k , i} ( θ ) ∝ {L}_{k} ( {ξ}_{k , i} \vert θ ) {μ}_{k , i - 1} ( θ ) . \qquad ( 3 )$$

The proportionality sign ∝ means that the entries of the resulting vector are normalized to add up to one, as befits a true probability mass function. The motivation for (3) is at least two-fold. From a behavioral point of view, Bayes's rule is used to model human reasoning under uncertainty in neuroscience and the social sciences. From a system design perspective, Bayes's rule is known to be an optimal information processing rule. In the next step, the intermediate beliefs are shared with other agents, which may average them in a geometric manner to form the updated belief using the confidence scores they assign to their neighbors as follows:

$${μ}_{k , i} ( θ ) ∝ {\prod }_{ℓ ∈ {𝒩}_{k}} {( {ψ}_{ℓ , i} ( θ ) )}^{{a}_{ℓ k}} . \qquad ( 4 )$$

The combination step (4) is a non-Bayesian way of combining beliefs and is inspired by the fact that humans are boundedly rational. In the above implementation, the agents are combining their neighbors' instantaneous opinions, as opposed to behaving in a fully Bayesian manner, which would require global information (such as the graph topology and access to all observations). This requirement makes the fully Bayesian solution NP-hard in general. Although there are variations based on the arithmetic averaging, this work primarily describes and considers the geometric averaging form described above.

An important quantity for the analysis of the strategy (3)-(4) is the log-belief ratio vector λᵢ [symbol] [λ_{1,i}(θ), . . . , λ_{K,i}(θ)]^{T} with individual entries defined as:

$${λ}_{k , i} ( θ ) {=}^{Δ} log \frac{{μ}_{k , i} ( θ° )}{{μ}_{k , i} ( θ )} . \qquad ( 5 )$$

For an agent k, if this quantity is positive for each θ≠θ°, then its belief vector is maximized at the true hypothesis and the agent can guess the correct hypothesis. It can be verified from the equations (3)-(4) that the vector λᵢ(θ) evolves according to the following linear recursion:

$${λ}_{i} ( θ ) = {A}^{T} ( {λ}_{i - 1} ( θ ) + {x}_{i} ( θ ) ) , \qquad ( 6 )$$

where xᵢ(θ) [symbol] [x_{1,i}(θ), . . . , x_{K,i}(θ)]^{T} is the vector of log-likelihood ratios (LLRs) at time

$${x}_{k , i} ( θ ) {=}^{Δ} log \frac{{L}_{k} ( {ξ}_{k , i} \vert θ° )}{{L}_{k} ( {ξ}_{k , i} \vert θ )} . \qquad ( 7 )$$

Theorem 1: Truth Learning. If agents employ the strategy (3)-(4), the asymptotic decay rate of a wrong hypothesis is equal for all agents and given by:

$$\frac{1}{i} {λ}_{k , i} ( θ ) {\to }^{a . s .} {\sum }_{ℓ = 1}^{K} {v}_{ℓ} {d}_{ℓ} ( θ ) . \qquad ( 8 )$$

Moreover, if global identifiability (Def. 1) holds, then all agents learn the truth with full confidence, i.e.:

$${μ}_{k , i} ( θ° ) {\to }^{a . s .} 1. \qquad ( 9 )$$

### 3.4 Adaptive Social Learning (ASL)

The traditional non-Bayesian social learning (NBSL) strategy (3)-(4) described in the previous section has the drawback that agents do not prioritize new observations against their old observations. In addition to falling short in modelling human behavior, this strategy can be disadvantageous for engineering applications that require adaptation under non-stationary environments. To tackle this issue, changing the adaptation step (3) into:

$${ψ}_{k , i} ( θ ) ∝ {L}_{k}^{β} ( {ξ}_{k , i} \vert θ ) {μ}_{k , i - 1}^{1 - δ} ( θ ) , \qquad ( 10 )$$

where 0<δ<1 and β>0 are design parameters. In particular, large values of δ or β place more focus on new observations, whereas small values give importance to past beliefs. The modified adaptation step (10) alters the log-belief ratio recursion (6) to

$${λ}_{i} ( θ ) = {A}^{T} ( ( 1 - δ ) {λ}_{i - 1} ( θ ) + β {x}_{i} ( θ ) ) . \qquad ( 11 )$$

In contrast to the NBSL case from the previous section where the beliefs converge to the truth almost surely (Theorem 1), in the adaptive social learning (ASL) strategy defined by steps (10) and (4), the beliefs will have everlasting random fluctuations that are necessary for keeping adaptation alive. The next result states that these random fluctuations have a regular behavior in the limit.

Theorem 2: Convergence in distribution. Under the ASL strategy (10) and (4), the log-belief ratios converge in distribution to the following absolutely convergent series:

$${λ}_{i} ( θ ) {\to }^{dist .} β {\sum }_{j = 1}^{∞} {( 1 - δ )}^{j - 1} {( {A}^{T} )}^{j} {x}_{j} ( θ ) . \qquad ( 12 )$$

Corollary 1 (Expected log-belief ratio in ASL) Theorem 2 implies that the log-belief ratios converge in the mean, i.e.:

$${lim}_{i \to ∞} 𝔼 [ {λ}_{i} ( θ ) ] = \frac{β}{1 - δ} ( {( I - ( 1 - δ ) {A}^{T} )}^{- 1} - I ) d ( θ ) \qquad ( 13 )$$

where d(θ) [symbol] [d₁(θ), d₂(θ), . . . , d_{K}(θ)]^{T} is the vector of network KL divergences.

Proof Since the series on the right hand side of (12) is uniformly integrable, the expectation on λᵢ(θ) converges to the expectation of the right hand side of (12). The result then follows from the fact that [symbol] [xⱼ(θ)]=d(θ) for any time j, and from the closed-form expression for the series of absolutely convergent matrices.

### 4 Causal Effects in Social Learning

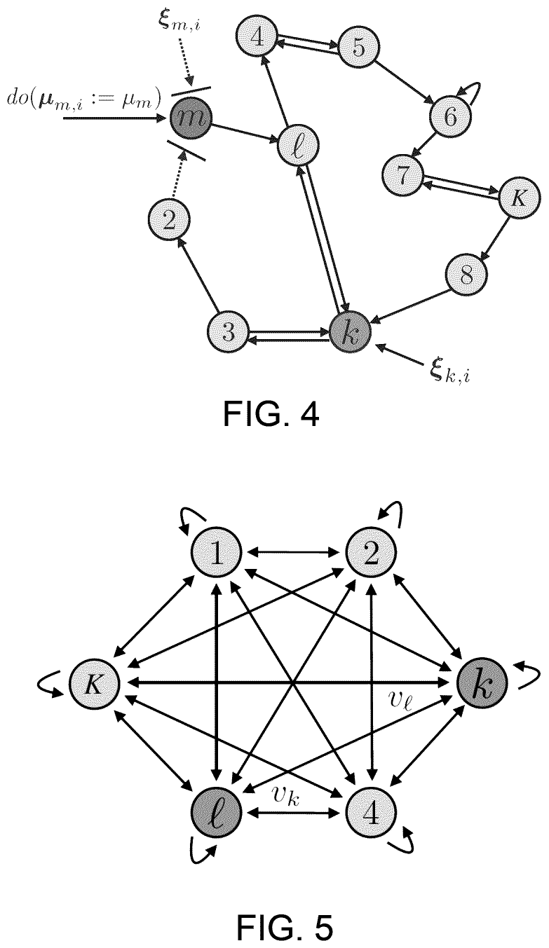

FIG. 4 illustrates an atomic and persistent intervention on an agent m=1 such as shown in FIG. 3 with respect to the case of a strongly connected network topology. That is, FIG. 4 provides a hypothetical intervention on the network topology of FIG. 3 with a goal of understanding the effect of agent m=1 thereupon. It should be noted agent m=1 is an illustrative configuration or condition used without loss of generality for the ease of presentation of the embodiments described herein.

An intuitive and widely used assertion in defining causality is that manipulation of the causes should result in changes in the effect. Based on this principle, interventions on a system, real or hypothetical, have been the primary tool for testing whether a variable causes another. In order to measure the causal influence strength between agents, this work relies on a most basic intervention known as atomic and persistent intervention. Specifically, in order to measure the social effect of an agent m on other agents, analyze the belief evolution of these other agents if the belief of agent m is fixed to some particular constant belief vector, illustratively, μ_{m,i}:μₘ for all time instants—see FIG. 5 for a visual depiction. In canonical causality notation, this intervention is denoted by do(μ_{m,i}:μₘ). Since the inventors consider only this intervention in this work and there is no room for ambiguity, they use the notation that the post-intervention counterparts of the variables in Sec. 3 are topped with the symbol ‘˜’. For example, the log-belief ratio definition from (5) transforms into the following, under the intervention do(μ_{m,i}: μₘ):

$${\tilde{λ}}_{k , i} ( θ ) {=}^{△} log \frac{{\tilde{μ}}_{k , i} ( θ° )}{{\tilde{μ}}_{k , i} ( θ )} . \qquad ( 14 )$$

### Causal Influence Strength.

Intuitively, the amount of change in the effect following an intervention on the cause is expected to be related to the causal strength. Therefore, the difference between the post and pre-intervention distributions, or between appropriate functions of these distributions such as expectations, can be used to quantify the causal effect. In this work, the inventors employ the following definition in order to measure the causal influence of agent m on agent k:

$${C}_{m \to k} {=}^{△} {μ}_{k , ∞} ( θ° ) - {\tilde{μ}}_{k , ∞} ( θ° ) \qquad ( 15 )$$

This formula measures the alteration of agent k as a consequence of an intervention on agent m. Specifically, it quantifies the magnitude of change of the expected asymptotic belief of agent k on the true state θ°. Here, use the following expression for the belief vector, which is explained in the sequel:

$${μ}_{k , ∞} ( θ° ) {=}^{△} \frac{1}{1 + {Σ}_{θ ∈ Θ ∖ \{ θ° \}} exp \{ - {λ}_{k , ∞} ( θ ) \}} . \qquad ( 16 )$$

This expression is defined in terms of the expected asymptotic log-belief ratio:

$${λ}_{k , ∞} ( θ ) {=}^{△} {lim}_{i \to ∞} 𝔼 [ {λ}_{k , i} ( θ ) ] \qquad ( 17 )$$

The variables topped with the symbol ‘˜’ for the intervention case are defined similarly (the existence of the limit for both NBSL and ASL under interventions will be discussed in the sequel). The transformation (16) is motivated by noting from (5) that:

$$exp \{ - {λ}_{k , i} ( θ ) \} = \frac{{μ}_{k , i} ( θ )}{{μ}_{k , i} ( θ° )} , \qquad ( 18 )$$

which implies

$$1 + {Σ}_{θ ∈ Θ ∖ \{ θ° \}} exp \{ - {λ}_{k , i} ( θ ) \} = \frac{1}{{μ}_{k , i} ( θ° )} {Σ}_{θ ∈ Θ} {μ}_{k , i} ( θ ) = \frac{1}{{μ}_{k , i} ( θ° )} , \qquad ( 19 )$$

which, in turn, yields

$${μ}_{k , i} ( {θ}^{∘} ) = \frac{1}{1 + {Σ}_{θ ∈ Θ ∖ \{ θ° \}} exp \{ - {λ}_{k , i} ( θ ) \}} . \qquad ( 20 )$$

Here, replacing log-belief ratio λ_{k,i} (θ) with the expected asymptotic log-belief ratio λ_{k,∞}(θ), arrives at the definition (16) for μ_{k,∞}(θ°). Note that defining μ_{k,c}(θ°) in terms of the expected log-belief ratios, as opposed to, say, expected beliefs (i.e., lim_{i˜∞} [symbol] [μ_{k,i} (θ°)]), will enable obtaining closed-form expressions for causality in terms of the informativeness of the agents, represented by the entries of d(θ), in Sec. 5. Next, treat NBSL and ASL separately.

Non-Bayesian social learning. In the idle case (i.e., no intervention) of NBSL, it is known from Theorem 1 that under global identifiability,

$${μ}_{k , i} ( θ° ) {\to }^{a . s .} 1$$

(i.e.,

$${λ}_{k , i} ( θ ) {\to }^{a . s .} + ∞$$

for each θ≠θ°). Hence, for the NBSL case, the average (i.e., expected) causal influence (15) is given by:

$${C}_{m \to k}^{NB} = 1 - {\tilde{μ}}_{k , ∞} ( θ° ) . \qquad ( 21 )$$

This immediately implies that

$${C}_{m \to k}^{NB} ∈ [ 0 , 1 ] ,$$

and it gets larger as the post-intervention belief diverges from the truth in expectation.

Adaptive social learning. In a similar fashion, the causal effect strength for the ASL case is given by the general expression (15):

$${C}_{m \to k}^{ASL} = {μ}_{k , ∞} ( θ° ) - {\tilde{μ}}_{k , ∞} ( θ° ) , \qquad ( 22 )$$

where the pre-intervention asymptotic belief μ_{k,∞}(θ°) can be found by inserting λ_{k,∞}(θ) established in Corollary 1 to (16).

Controllability. Notably, the influence C_{m→k} of agent m on agent k can also be interpreted as the controllability or manipulability of agent k by agent m.

### 5 Theoretical Results

This section derives closed-form expressions for \tilde{λ}_{k,∞} [symbol] [\tilde{λ}_{k,∞}(θ₁), . . . , \tilde{λ}_{k,∞}(θ_{H})]^{T} in terms of the network topology and the informativeness of agents to obtain the causal strength measures

$${C}_{m \to k}^{NB} and {C}_{m \to k}^{ASL} .$$

For ease of notation and without loss of generality, set m=1. One can obtain

$${C}_{m \to k}^{NB}$$

by setting β=1 and δ→0 in

$${C}_{m \to k}^{ASL}$$

due to (3) and (10). Nevertheless, first present the analysis for NBSL since it is easier to derive and provides useful insights for ASL. Provided below are results for NBSL.

### 5.1 Non-Bayesian Social Learning

The intervention do(μ_{1,i}:=μ₁) ceases (or obstructs the use of) all incoming information at agent 1 from the neighbors [symbol] and the use of the streaming observations ξ_{1,i} from the environment. Consequently, the inventors can model this effect by redefining the combination matrix and the LLR vector counterparts under the intervention:

$$\tilde{A} {=}^{Δ} [ {\tilde{a}}_{ℓ k} ] , {\tilde{a}}_{ℓ k} {=}^{Δ} 1 , ℓ = k = 1 \qquad ( 23 )$$

$$0 , ℓ \neq k = 1 \qquad ( 24 )$$

$${a}_{ℓ k} , ℓ \neq 1 , k \neq 1 , {\tilde{x}}_{i} ( θ ) {=}^{Δ} {[ 0 , {x}_{2 , i} ( θ ) , … , {x}_{K , i} ( θ ) ]}^{T} . \qquad ( 25 )$$

Observe that the effective combination matrix Ã can be obtained from A as follows:

$$A = [ \begin{matrix}{a}_{11} & {r}^{T} \\ \begin{matrix}{a}_{21} \\ ⋮ \\ {a}_{K 1}\end{matrix} & R\end{matrix} ] ⟹ \tilde{A} = [ \begin{matrix}1 & {r}^{T} \\ 0 & R\end{matrix} ] , \qquad ( 26 )$$

for a (K−1)×1 dimensional vector r and and a (K−1)×(K−1) dimensional matrix R:

$$\begin{matrix}r {=}^{Δ} {[ \begin{matrix}{a}_{12} & {a}_{13} & … & {a}_{1 K}\end{matrix} ]}^{T} , & R {=}^{Δ} [ \begin{matrix}{a}_{22} & ⋯ & {a}_{2 K} \\ ⋮ & ⋱ & ⋮ \\ {a}_{K 2} & ⋯ & {a}_{KK}\end{matrix} ] .\end{matrix} \qquad ( 27 )$$

The matrix structure of Ã belongs to the class of general combination matrices that arise in the analysis of weakly connected networks. As opposed to the strongly connected networks where information can flow thoroughly, in weakly connected networks information can flow only in one direction between certain parts of the network. In the current context, this corresponds to the fact that information continues to flow from agent 1 in the form of its belief vector fixed at μₘ, but no information is flowing into it in the sense that agent 1 ignores all signals arriving from its neighbors and does not use them to update its local belief. However, in contrast to these prior works that analyze opinion dynamics under weakly connected networks, the inventors are interested in the effect of the intervention on the original strongly connected network. This alters the LLR xᵢ(θ) as well—see (23). Similar to the original case in (6), the inventors proceed by studying the log-belief ratio evolution that results from using Ã:

$${\tilde{λ}}_{i} ( θ ) = {\tilde{A}}^{T} ( {\tilde{λ}}_{i - 1} ( θ ) + {\tilde{x}}_{i} ( θ ) ) . \qquad ( 28 )$$

The i-fold expansion of (28) gives

$${\tilde{λ}}_{i} ( θ ) = {\sum }_{j = 1}^{i} {( {\tilde{A}}^{i - j + 1} )}^{T} {\tilde{x}}_{j} ( θ ) + {( {\tilde{A}}^{i} )}^{T} {\tilde{λ}}_{0} ( θ ) . \qquad ( 29 )$$

To study (29), evaluate the powers of the effective combination matrix:

$${\tilde{A}}^{i} = [ \begin{matrix}1 & {{r}_{i}^{′}}^{T} \\ 0 & {R}^{i}\end{matrix} ] , \qquad ( 30 )$$

$${\tilde{A}}^{∞} {=}^{( a )} [ \begin{matrix}1 & 1 … 1 \\ 0 & 0\end{matrix} ]$$

where (a) follows from the fact that the spectral radius of the matrix R is strictly smaller than 1, i.e., R is a stable matrix. For each time i and 0<j≤i, observe that

$${( {\tilde{A}}^{i - j + 1} )}^{T} {\tilde{x}}_{j} ( θ ) {=}^{( 23 ) , ( 30 )} [ \begin{matrix}1 & 0 \\ {r}_{i - j + 1}^{′} & {R}^{i - j + {1}^{T}}\end{matrix} ] [ \begin{matrix}0 \\ {x}_{2 , j} ( θ ) \\ ⋮ \\ {x}_{K , j} ( θ )\end{matrix} ] \qquad ( 31 )$$

$$⟹ {[ {( {\tilde{A}}^{i - j + 1} )}^{T} {\tilde{x}}_{j} ( θ ) ]}_{1} = 0 \qquad ( 32 )$$

$$and$$

$${( {\tilde{A}}^{i} )}^{T} {\tilde{λ}}_{0} ( θ ) {=}^{( 23 ) , ( 30 )} [ \begin{matrix}1 & 0 \\ {r}_{i}^{′} & {R}^{{i}^{T}}\end{matrix} ] [ \begin{matrix}log \frac{{μ}_{1} ( θ° )}{{μ}_{1} ( θ )} . \\ log \frac{{μ}_{2 , 0} ( θ° )}{{μ}_{2 , 0} ( θ )} . \\ ⋮ \\ log \frac{{μ}_{K , 0} ( θ° )}{{μ}_{K , 0} ( θ )} .\end{matrix} ] \qquad ( 33 )$$

$$⟹ {[ {( {\tilde{A}}^{i} )}^{T} {\tilde{λ}}_{0} ( θ ) ]}_{1} = log \frac{{μ}_{1} ( θ° )}{{μ}_{1} ( θ )} . \qquad ( 34 )$$

Inserting these into (29) verifies that the intervention is fixed as intended for all time instants, since

$${[ {\tilde{λ}}_{i} ( θ ) ]}_{1} {=}^{( 29 )} {\sum }_{j = 1}^{i} {[ {( {\tilde{A}}^{i - j + 1} )}^{T} {\tilde{x}}_{j} ( θ ) ]}_{1} + {[ {( {\tilde{A}}^{i} )}^{T} {\tilde{λ}}_{0} ( θ ) ]}_{1} . \qquad ( 35 )$$

$${\tilde{λ}}_{1 , i} ( θ ) {=}^{( 32 ) , ( 34 )} log \frac{{μ}_{1} ( {θ}^{o} )}{{μ}_{1} ( θ )} , {\tilde{μ}}_{1 , i} ( θ ) = {μ}_{1} ( θ ) . \qquad ( 36 )$$

Moreover, if taking the expectation of both sides of (29), then:

$$\begin{matrix}𝔼 [ {\tilde{λ}}_{i} ( θ ) ] = {\sum }_{j = 1}^{i} {( {\tilde{A}}^{i - j + 1} )}^{T} 𝔼 [ {\tilde{x}}_{j} ( θ ) ] + {( {\tilde{A}}^{i} )}^{T} 𝔼 [ {\tilde{λ}}_{0} ( θ ) ] \\ = {\sum }_{j = 1}^{i} {( {\tilde{A}}^{i - j + 1} )}^{T} \tilde{d} ( θ ) + {( {\tilde{A}}^{i} )}^{T} 𝔼 [ {\tilde{λ}}_{0} ( θ ) ] .\end{matrix} \qquad ( 37 )$$

where the definition \tilde{d}(θ) [symbol] [0,d₂(θ), . . . , d_{K}(θ)]^{T} is used. Hence, in the limit (the existence is guaranteed by the finiteness of LLRs and positive initial beliefs), it holds that

$$( 38 )$$

$${lim}_{i \to ∞} 𝔼 [ {\tilde{λ}}_{i} ( θ ) ] = {lim}_{i \to ∞} {\sum }_{j = 1}^{i} {( {Ã}^{i - j + 1} )}^{T} \tilde{d} ( θ ) + {( {Ã}^{∞} )}^{T} 𝔼 [ {\tilde{λ}}_{0} ( θ ) ] = {\sum }_{j = 1}^{∞} {( {Ã}^{j} )}^{T} \tilde{d} ( θ ) + {( {Ã}^{∞} )}^{T} 𝔼 [ {\tilde{λ}}_{0} ( θ ) ] .$$

This implies for the log-belief ratios of all agents except agent m=1 that:

$$( 39 )$$

$${\tilde{λ}}_{- m , ∞} ( θ ) {=}^{△} {[ {\tilde{λ}}_{2 , ∞} ( θ ) , … , {\tilde{λ}}_{K , ∞} ( θ ) ]}^{T} = {\sum }_{j = 1}^{∞} {( {R}^{j} )}^{T} {d}_{- m} ( θ ) + ( log \frac{{μ}_{1} ( θ° )}{{μ}_{1} ( θ )} ) {1}_{K - 1}$$

where d₋ₘ(θ) is the (K−1)×1 dimensional vector of local KL divergences of the remaining agents, i.e.,

$${d}_{- m} ( θ ) {=}^{△} col {\{ {d}_{ℓ} ( θ ) \}}_{ℓ = 2}^{K} .$$

Since R is a stable matrix [59, Lemma 1], Eq. (39) can alternatively be written as:

$$\begin{matrix}{\tilde{λ}}_{- m , ∞} ( θ ) = ( {( I - {R}^{T} )}^{- 1} - I ) {d}_{- m} ( θ ) + ( log \frac{{μ}_{1} ( θ° )}{{μ}_{1} ( θ )} ) {1}_{K - 1}\end{matrix} \qquad ( 40 )$$

The causal influence of agent m=1 on agent k can now be calculated by inserting \tilde{λ}_{k,∞}(θ) into (16) to find \tilde{μ}_{k,m}(θ), which is the input for (21) that yields

$${C}_{m \to k}^{NB} .$$

Equation (40) is a general result which shows that

$${C}_{m \to k}^{NB}$$

is a function of (i) the combination weights (via R), and (ii) the individual informativeness of each agent (via d₋ₘ(θ)).

Furthermore,

$${C}_{m \to k}^{NB}$$

represents a dose-response curve, assuming different values for different intervention strengths (i.e., dose) μ₁=μₘ. This is a typical situation in the context of continuous-valued interventions. In some applications, however, it proves beneficial to encapsulate the causal effect value with a single number. For this purpose, may set μₘ to be uniform across all hypotheses, i.e., μₘ(θ)=1/H, ∀θ∈Θ. This method of summarizing the causal effect is denoted as follows:

$${\overline{C}}_{m \to k}^{NB} {=}^{△} {C}_{m \to k}^{NB} {\vert}_{{μ}_{m} ( θ ) = 1 / H} \qquad ( 41 )$$

This choice effectively parallels the process of determining the average causal derivative effect, which is a method commonly used in the literature for summarizing the causal effect. Basically, it quantifies the extent of change in agent k in response to an infinitesimal variation in the intervention strength μₘ.

The next section studies two special network topologies that help illustrate the dependencies of the causal effect more explicitly.

### 5.1.1 Special Cases

### Fully-Connected and Federated Architectures.

FIG. 5 illustrates a fully connected network topology. Specifically, FIG. 5 illustrates a fully connected network topology with a rank-one combination matrix and Perron vector v, i.e.:

$$A = [ \begin{matrix}{v}_{1} & {v}_{1} & … & {v}_{1} \\ {v}_{2} & {v}_{2} & … & {v}_{2} \\ ⋮ & ⋮ & ⋱ & ⋮ \\ {v}_{K} & {v}_{K} & … & {v}_{K}\end{matrix} ] = v {1}_{K}^{T} . \qquad ( 42 )$$

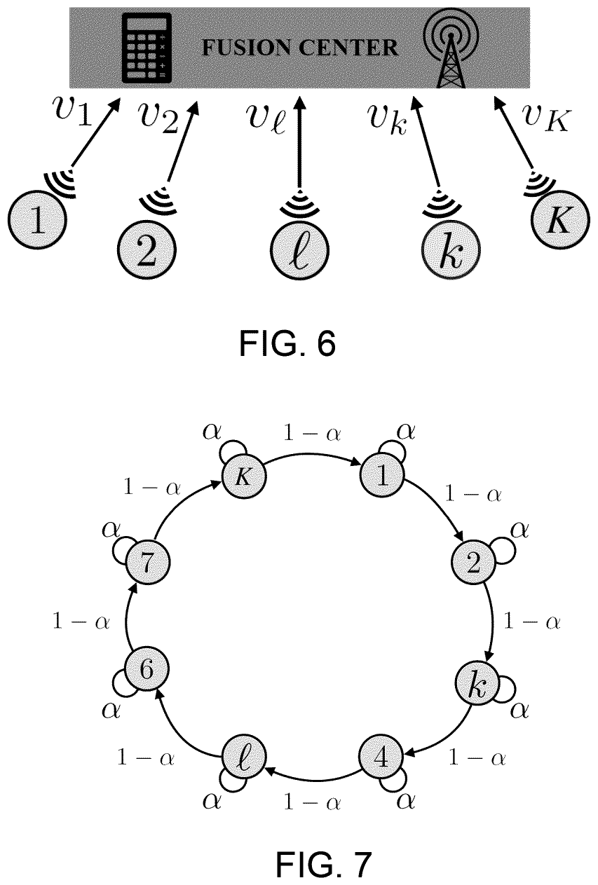

Note that in terms of performance, this system is equivalent to a federated architecture in which (i) agents send their beliefs to a fusion center after local adaptation, (ii) the center averages the received beliefs in a weighted manner, and (iii) then broadcasts the combined belief to all agents, as shown in FIG. 6, which illustrates a federated architecture. The server broadcasts the weighted average of agents' beliefs back to them at each iteration. In terms of performance, this system is equivalent to the fully connected architecture of FIG. 4.

Under intervention do(μ_{1,i}: =μ₁), it is provided that:

$$\tilde{A} = [ \begin{matrix}1 & {v}_{1} & … & {v}_{1} \\ 0 & {v}_{2} & … & {v}_{2} \\ ⋮ & ⋮ & ⋱ & ⋮ \\ 0 & {v}_{K} & … & {v}_{K}\end{matrix} ] ⇒ R = [ \begin{matrix}{v}_{2} & … & {v}_{2} \\ ⋮ & ⋱ & ⋮ \\ {v}_{K} & … & {v}_{K}\end{matrix} ] = {v}_{- m} {1}_{K - 1}^{T} \qquad ( 43 )$$

where

$${v}_{- m} {=}^{△} col {\{ {v}_{ℓ} \}}_{ℓ = 2}^{K}$$

l is a (K−1)×1 dimensional vector consisting of all Perron entries except for agent m=1.

Observe that:

$${R}^{2} = {v}_{- m} {1}_{K - 1}^{T} {v}_{- m} {1}_{K - 1}^{T} {=}^{( a )} ( 1 - {v}_{1} ) {v}_{- m} {1}_{K - 1}^{T} , \qquad ( 44 )$$

where (a) follows from the fact that

$${1}_{K}^{T} v = 1. \qquad ( Eq . ( 2 ) )$$

Repeating the same arguments, it holds that:

$${R}^{i} = {( 1 - {v}_{1} )}^{i - 1} {v}_{- m} {1}_{K - 1}^{T} . \qquad ( 45 )$$

Therefore,

$${( I - {R}^{T} )}^{- 1} - I = {\sum }_{i = 1}^{∞} {( {R}^{T} )}^{i} = {1}_{K - 1} {v}_{- m}^{T} {\sum }_{i = 1}^{∞} {( 1 - {v}_{1} )}^{i - 1} = \frac{1}{{v}_{1}} {1}_{K - 1} {v}_{- m}^{T} . \qquad ( 46 )$$

Inserting this into (40), arrive at the following expression for each agent k≠1:

$${\tilde{λ}}_{k , ∞} ( θ ) = \frac{1}{{v}_{1}} {\sum }_{ℓ = 2}^{K} {v}_{ℓ} {d}_{ℓ} ( θ ) + log \frac{{μ}_{1} ( θ° )}{{μ}_{1} ( θ )} \qquad ( 47 )$$

Combining (16) and (21) with (47) yields the causal effect:

$${C}_{m \to k}^{NB} {=}^{( 16 ) , ( 21 )} 1 - \frac{1}{1 + {\sum }_{θ ∈ Θ \backslash \{ θ° \}} exp \{ - {\tilde{λ}}_{k , ∞} ( θ ) \}} {=}^{( 16 ) ( 21 ) ( 47 )} 1 - \frac{1}{1 + {\sum }_{θ ∈ Θ \backslash \{ θ° \}} \frac{{μ}_{m} ( θ )}{{μ}_{m} ( θ° )} exp \{ - \frac{1}{{v}_{1}} {\sum }_{ℓ = 2}^{K} {v}_{ℓ} {d}_{ℓ} ( θ ) \}} . \qquad ( 48 )$$

The effect of agent m on all other agents is the same, which is expected due to the symmetric nature of this special example. Furthermore, observe that the causal effect

$${C}_{m \to k}^{NB}$$

decreases with increasing \tilde{λ}_{k,∞}(θ). On that account, from (47) it can be seen that:
Increasing the network centrality of agent m=1 (i.e., increasing v₁) decreases \tilde{λ}_{k,∞}(θ), and in turn increases the causal effect

$${C}_{m \to k}^{NB} .$$

Therefore, an agent has more effect on other agents if it has a higher network centrality. In particular, if

$${v}_{1} \to 0 ⇒ {\tilde{λ}}_{k , ∞} ( θ ) \to + ∞ ⇒ {C}_{m \to k}^{NB} \to 0 , \qquad ( 49 )$$

which means that an agent with negligible network centrality has no causal effect on other agents.
   Increasing network centrality and informativeness of the other agents [symbol] ≠1 (i.e., increasing [symbol] and [symbol] (θ)) increases \tilde{λ}_{k,∞}(θ), and in turn decreases the causal effect

$${C}_{m \to k}^{NB} .$$

In particular, if the most informative agents are equipped with the highest network centrality, then

$${\sum }_{ℓ = 2}^{K} {v}_{ℓ} {d}_{ℓ} ( θ )$$

is large and it is harder for agent 1 to control other agents.
   If the fixed belief on the true hypothesis μₘ(θ°) decreases, then \tilde{λ}_{k,i}(θ) decreases and the causal effect

$${C}_{m \to k}^{NB}$$

increases. This suggests that the further from the truth the information an agent supplies, the more effect that agent will have on other agents. In other words, agents supplying misinformation have more effect on the rest of the network. Specifically, observe that if the rest of the agents have a low informativeness average, i.e., if

$${\sum }_{ℓ = 2}^{K} {v}_{ℓ} {d}_{ℓ} ( θ ) \approx 0 ⇒ {C}_{m \to k}^{NB} \approx 1 - {μ}_{m} ( θ° ) . \qquad ( 50 )$$

Therefore, the causal effect is proportional to the difference from the truth. It is maximized

$$( i . e . , {C}_{m \to k}^{NB} = 1 )$$

when the fixed belief assigns 0 to the true hypothesis.

### Ring Architecture.

FIG. 7 illustrates a unidirectional ring. In this example, consider a unidirectional ring network where each agent has a self-confidence of a, and assigns a confidence of 1−α to the preceding agent in the ring of FIG. 7. Agents are indexed such that agent k+1 receives (or uses) information from agent k only. The combination matrix has the form:

$$A = [ \begin{matrix}α & 1 - α & 0 & … & 0 \\ 0 & α & 1 - α & … & 0 \\ ⋮ & 0 & α & … & ⋮ \\ 0 & ⋮ & ⋮ & ⋱ & 1 - α \\ 1 - α & 0 & 0 & … & α\end{matrix} ] . \qquad ( 51 )$$

Under intervention do(μ_{1,i}:=μ₁), we have

$$\tilde{A} = [ \begin{matrix}1 & 1 - α & 0 & … & 0 \\ 0 & α & 1 - α & … & 0 \\ 0 & 0 & α & … & ⋮ \\ ⋮ & ⋮ & ⋮ & ⋱ & 1 - α \\ 0 & 0 & 0 & … & α\end{matrix} ] ⇒ R = [ \begin{matrix}α & 1 - α & … & 0 \\ 0 & α & … & ⋮ \\ ⋮ & ⋮ & ⋱ & 1 - α \\ 0 & 0 & … & α\end{matrix} ] . \qquad ( 52 )$$

As a result,

$$( I - {R}^{T} ) = ( 1 - α ) [ \begin{matrix}1 & 0 & … & 0 \\ - 1 & 1 & … & 0 \\ ⋮ & ⋮ & ⋱ & ⋮ \\ 0 & … & - 1 & 1\end{matrix} ] ⇒ {( I - {R}^{T} )}^{- 1} = \frac{1}{1 - α} [ \begin{matrix}1 & 0 & … & 0 \\ 1 & 1 & … & 0 \\ ⋮ & ⋮ & ⋱ & ⋮ \\ 1 & 1 & … & 1\end{matrix} ] , \qquad ( 53 )$$

which implies

$$( {( I - {R}^{T} )}^{- 1} - I ) {d}_{- m} ( θ ) = {\frac{1}{1 - α} [ α {d}_{2} ( θ ) , {d}_{2} ( θ ) + α {d}_{3} ( θ ) , ... , {\sum }_{ℓ = 2}^{K - 1} {d}_{ℓ} ( θ ) + α {d}_{K} ( θ ) ]}^{T} . \qquad ( 54 )$$

Consequently, for agent k,

$${\tilde{λ}}_{k , ∞} ( θ ) = \frac{1}{1 - α} {\sum }_{ℓ = 2}^{k - 1} {d}_{ℓ} ( θ ) + \frac{α}{1 - α} {d}_{k} ( θ ) + log \frac{{μ}_{1} ( θ° )}{{μ}_{1} ( θ )} \qquad ( 55 )$$

and, in addition, by definitions (16) and (21),

$${C}_{m \to k}^{NB} = 1 - \frac{1}{1 + {\sum }_{θ ∈ Θ \backslash \{ θ° \}} \frac{{μ}_{m} ( θ )}{{μ}_{m} ( θ° )} exp \{ - \frac{1}{1 - α} {\sum }_{ℓ = 2}^{k - 1} {d}_{ℓ} ( θ ) - \frac{α}{1 - α} {d}_{k} ( θ ) \}} . \qquad ( 56 )$$

As stated before, the causal effect

$${C}_{m \to k}^{NB}$$

decreases with increasing \tilde{λ}_{k,∞}(θ). Therefore, the following remarks for (55) and (56) are in place:
Since the KL divergence [symbol] (θ) is non-negative, \tilde{λ}_{k,∞}(θ) is monotonically increasing along the path k=2→ . . . →k=K. Therefore, the causal effect of agent m=1 is monotonically decreasing along the same path: the closer agent 1 is to an agent, the higher its effect on that agent. This is intuitive because the effect that agent 1 has on agent k+1 is transferred via agent k in the ring structure. The difference between the causal effects of agent 1 on agents k and k+1 is proportional to the increase in \tilde{λ}_{k,∞}(θ), that is,

$${\tilde{λ}}_{k + 1 , ∞} ( θ ) - {\tilde{λ}}_{k , ∞} ( θ ) = {d}_{k} ( θ ) + \frac{α}{1 - α} {d}_{k + 1} ( θ ) . \qquad ( 57 )$$

This means that informative agents with high KL divergence on the path between agent m and agent k reduce the causal effect

$${C}_{m \to k}^{NB} .$$

In other words, the sphere of influence of an agent m is bigger if there are no other informative agents in the vicinity.
For the immediate follower of agent 1, it follows that

$${\tilde{λ}}_{2 , ∞} ( θ ) = \frac{α}{1 - α} {d}_{2} ( θ ) + log \frac{{μ}_{1} ( θ° )}{{μ}_{1} ( θ )} . \qquad ( 58 )$$

If agent 2 is not sufficiently informative itself, i.e., d₂(θ) is small, then \tilde{λ}_{2,∞}(θ) gets smaller and

$${C}_{1 \to 2}^{NB}$$

gets higher. In other words, an agent is more controllable if it is not knowledgeable.
The limiting average \tilde{λ}_{k,∞}(θ) increases with increasing α. Therefore, if agents are more self-confident, the causal strength is smaller and agents are less controllable by other agents.

### 5.2 Adaptive Social Learning

Similar to the modification in the NBSL case, the log-belief recursion (11) in ASL is modified as follows under intervention do(μ_{1,i}:μ₁):

$${\tilde{λ}}_{i} ( θ ) = {\tilde{A}}^{T} ( ( 1 - δ ) {\tilde{λ}}_{i - 1} ( θ ) + β {\tilde{x}}_{i} ( θ ) ) . \qquad ( 59 )$$

The effective combination matrix A continues to be given by (23). However, the effective LLR is now given by

$${\tilde{x}}_{i} ( θ ) {=}^{Δ} {[ \frac{δ}{β} log \frac{{μ}_{1} ( θ° )}{{μ}_{1} ( θ )} , {x}_{2 , i} ( θ ) , ... , {x}_{K , i} ( θ ) ]}^{T} , \qquad ( 60 )$$

where the first entry is different than the NBSL case. This is to compensate for the presence of the parameters δ and β. Observe from (59) that Ã from (23) and \tilde{x}ᵢ (θ) from (60) verify

$${\tilde{λ}}_{1 , i} ( θ ) = log \frac{{μ}_{1} ( θ° )}{{μ}_{1} ( θ )}$$

for all time instants, i.e., the intervention is fixed, by similar arguments to (36). The limiting log-belief ratio expectations for the rest of the network is:

$${\tilde{λ}}_{- m , ∞} ( θ ) = ( log \frac{{μ}_{1} ( θ° )}{{μ}_{1} ( θ )} ) {( I - ( 1 - δ ) {R}^{T} )}^{- 1} r + \frac{β}{1 - δ} ( {( I - ( 1 - δ ) {R}^{T} )}^{- 1} - I ) {d}_{- m} ( θ ) \qquad ( 61 )$$

The causal effect

$${C}_{m \to k}^{ASL}$$

can be calculated by inserting post-intervention expression (61) and pre-intervention expression (13) into the definitions (16) and (22). Notice from (61) that similar to the NBSL case, the causal effect depends on the informativeness of agents, the network topology, and the strength of intervention via d₋ₘ(θ), R, and μ₁, respectively. In fact, if we set δ=0 and β=1, Eq. (61) reduces to the NBSL expression (40) as expected. This is because the left-stochastic nature of A implies that

$$r + {R}^{T} {1}_{K - 1} = {1}_{K - 1} ⇔ {( I - {R}^{T} )}^{- 1} r = {1}_{K - 1} . \qquad ( 62 )$$

In addition, the causal effects in ASL are affected by the importance weighting parameters δ and β, as well as by the vector r that represents the confidence weights other agents assign to agent m. In (40), the entries of r implicitly influence the causal effect via R: the column-wise summation of the entries of r and R results in 1 at all columns due to the left-stochastic nature of A. In comparison, in ASL, both r and R impact

$${C}_{m \to k}^{ASL}$$

explicitly. If we take a closer look at the terms in (61), it can be seen that:
The vector that scales the intervened log-belief ratio

$$log \frac{{μ}_{1} ( θ° )}{{μ}_{1} ( θ )}$$

can be expanded as

$${( I - ( 1 - δ ) {R}^{T} )}^{- 1} r = r + ( 1 - δ ) {R}^{T} r + {( 1 - δ )}^{2} {R}^{2 T} r + {( 1 - δ )}^{3} {R}^{3 T} + … \qquad ( 63 )$$

On the right hand side of this equation, the first r represents the scaling of the information transferred from agent m to the rest of the network directly. Namely, for an agent k, the scaling of the direct information is aₘₖ if m is an immediate neighbor (m∈ [symbol] ); 0 if it is not (m∉ [symbol] ). On the other hand, the second term (1−δ)R^{T}r describes the scaling of the information transferred from agent m to the rest of the network, which is then mixed with the other agents ∀k≠m (via R^{T}) and “forgotten” (i.e., lose its recency) for one time instant by a factor of (1-6). The consecutive terms over time follow from the same scaling argument.
In a similar manner, we can express the matrix that scales the vector of individual informativeness in the rest of the network d₋ₘ(θ) as:

$$\frac{1}{1 - δ} ( {( I - ( 1 - δ ) {R}^{T} )}^{- 1} - I ) = {R}^{T} + ( 1 - δ ) {R}^{2 T} + {( 1 - δ )}^{2} {R}^{3 T} + … \qquad ( 64 )$$

Since there is no outgoing link from the rest of the network to agent m=1 under the intervention, the terms in this expression only depend on the combination matrix R. When new information arrives to the remaining agents, it is first mixed among these agents (corresponding to the first term R^{T} on right hand side), and then in the next iteration, it is mixed again but also gets forgotten due to the time discount factor δ (corresponding to the second term (1−δ)R^{2T} on right hand side), and so on.
Remember from (10) that β>0 scales the likelihood of observations, reflecting the weight agents place on their own observations originating from out-of-network sources. As a result, notice that in (61), β scales the individual informativeness [symbol] (θ), ∀ [symbol] ≠m. In other words, it amplifies the effect of self observations on the state of nature.

Next is analyzed the special cases introduced in the NBSL case under ASL framework.

### 5.2.1 Special Cases

### Fully-Connected and Federated Architectures.

The additional δ and β parameters introduced for the ASL change the NBSL expression (47) to

$${\tilde{λ}}_{k , ∞} ( θ ) = \frac{1}{1 - ( 1 - δ ) ( 1 - {v}_{1} )} ( β {\sum }_{ℓ = 2}^{K} {v}_{ℓ} {d}_{ℓ} ( θ ) + {v}_{1} log \frac{{μ}_{1} ( θ° )}{{μ}_{1} ( θ )} ) \qquad ( 65 )$$

Notice that as δ→0 and β→1, (65) recovers (47) as expected, and the following remarks from the NBSL case continue to hold here: (i) the influence of an agent m=1 is identical for each agent k≠1 due to symmetry in the network topology, (ii) increasing the network centrality of agent m increases its causal influence, and (iii) increasing the network centrality and informativeness of the rest of the agents [symbol] ≠1 decreases the causal effect of m=1. Moreover, since causal effect

$${C}_{m \to k}^{ASL}$$

is a monotonic decreasing function of \tilde{λ}_{k,∞}(θ) by (22), Eq. (65) also implies the following conclusions:
As stated after (61), β scales the informativeness of agents. Accordingly, (65) reveals that the causal effect is decreasing with increasing β. This is justifiable because as agents have greater reliance on their own observations about the state of nature, they are less influenced by other agents in the network. It is worth mentioning that in (65), the intervened log-belief ratio

$$log \frac{{μ}_{1} ( θ° )}{{μ}_{1} ( θ )}$$

behaves as “pseudo-informativeness”. It is scaled with the Perron entry v₁ of agent m=1, similar to how the rest of the agents' informativeness is scaled with their own Perron entries. The difference is that the other agents' informativeness are based on their log-likelihood ratios averaged with respect to the true distribution, whereas the intervened log-belief ratio can be arbitrary, possibly supplying misinformation.
In the special case of the rest of the agents having no informativeness (i.e., [symbol] (θ)=0, ∀ [symbol] ≠1), the limiting mean log-belief ratio vector in (65) turns into

$${\tilde{λ}}_{k , ∞} ( θ ) = \frac{1}{1 + δ ( \frac{1}{{v}_{1}} - 1 )} log \frac{{μ}_{1} ( θ° )}{{μ}_{1} ( θ )} . \qquad ( 66 )$$

This is in contrast to the NBSL case, where,

$${\tilde{λ}}_{k , ∞} ( θ ) = log \frac{{μ}_{1} ( θ° )}{{μ}_{1} ( θ )} .$$

In other words, in steady-state of NBSL, the average beliefs of all agents become equal to the intervened fixed belief μ₁, implying full controllability. In ASL, however, the controllability is reduced by a factor of (1+δ(1/v₁−1))≥1 as shown in (66). In particular, increasing the forgetting factor δ decreases controllability, especially when the network centrality of “controlling” agent m=1 is small. However, if agent m is highly central, i.e., v₁→1, then the forgetting factor δ has negligible effect on controllability.
Considering the general case (65), note that unlike β which only affects non-intervened observations, δ affects both intervened beliefs and non-intervened observations. Thus, to fully understand the impact of δ on the overall causal effect, consider the exact values of the relevant parameters.

### Ring Architecture.

The additional δ and β parameters introduced for the ASL change the NBSL expression (66) to:

$${λ}_{k , ∞} ( θ ) = ( log \frac{{μ}_{1} ( θ° )}{{μ}_{1} ( θ )} ) \frac{{( 1 - δ )}^{k - 2} {( 1 - α )}^{k - 1}}{{( 1 - ( 1 - δ ) α )}^{k - 1}} + \frac{βα}{1 - ( 1 - δ ) α} {d}_{k} ( θ ) + \frac{β}{1 - δ} {\sum }_{ℓ = 2}^{k - 1} \frac{{( 1 - δ )}^{k - ℓ} {( 1 - α )}^{k - ℓ}}{{( 1 - ( 1 - δ ) α )}^{k - ℓ + 1}} {d}_{ℓ} ( θ ) \qquad ( 66 ’ )$$

from which can be made the following observations:
   As δ→0 and β→1, the NBSL expression (66) for ring architectures is recovered. Similar to the earlier expressions, the causal effect decreases with increasing informativeness of agents along the path between m=1 and k ( [symbol] =2, . . . , k−1) (the last term on right hand side), and also decreases with increasing informativeness of agent k. Informativeness is scaled by β as before.
   Recall that in NBSL, if the rest of the agents have no informativeness, it holds that

$${\tilde{λ}}_{k , ∞} ( θ ) = log \frac{{μ}_{1} ( θ° )}{{μ}_{1} ( θ )} .$$

In other words, agent m=1 can fully control other agents' beliefs. Instead, in ASL, if [symbol] (θ)=0, ∀ [symbol] , it holds that

$${\tilde{λ}}_{k , ∞} ( θ ) = \frac{{( 1 - δ )}^{k - 2} {( 1 - α )}^{k - 1}}{{( 1 - ( 1 - δ ) α )}^{k - 1}} ( log \frac{{μ}_{1} ( θ° )}{{μ}_{1} ( θ )} ) = \frac{1}{1 - δ} {( 1 - \frac{1}{\frac{1 - α}{δ} + α} )}^{k - 1} ( log \frac{{μ}_{1} ( θ° )}{{μ}_{1} ( θ )} ) . \qquad ( 67 )$$

Observe that as the agent index k increases, the controllability decays at each hop by a factor of

$$\frac{{\tilde{λ}}_{k + 1 , ∞} ( θ )}{{\tilde{λ}}_{k , ∞} ( θ )} = 1 - \frac{1}{\frac{1 - α}{δ} + α} ∈ [ 0 , 1 ] . \qquad ( 68 )$$

The decrease is higher when δ is higher because the information from agent 1 gets “partially forgotten” at each hop as k (i.e., the distance to agent 1) increases. However, in general, the informativeness of agents along the path is not 0, and they have a shadowing effect on agent 1's influence, as argued before. The forgetting factor δ decreases this shadowing effect as well, particularly for agents far from agent k.

### 6 Causal Ranking of Agents

In the previous sections, examined the bipartite influence between agents was examined; that is, how much an agent m affects another agent k in the network. By calculating this influence for any pair of agents (m,k), we can construct a K×K influence matrix C with entries [C]ₘₖ=C_{m→k}. One is often interested in the overall influence of agent m on the network rather than its effect on individual agents. To that end, this section describes a procedure to use C for ranking and quantifying the agents' cumulative effect over the network.

Since C is constructed from intervened belief dependent entries C_{m→k}, an ordering based on C would be valid for a particular intervention. For an intervention dose independent ranking of agents, one can consider the matrix C̅, which is formed with dose independent causal effects C̅_{m→k}:

$${\overline{C}}_{m \to k} {=}^{Δ} {C}_{m \to k} {\vert}_{{μ}_{m} ( θ ) = 1 / H} \qquad ( 69 )$$

where we extend the definition (41) for the NBSL case to the general case. For simplicity of the presentation, in the sequel, we focus on the NBSL case, even though the arguments keep holding for a general C̅ as well as an ordering based on intervention dose dependent matrix C, too.

First, note that the causal effect for the NBSL case is given by:

$${C}_{m \to k}^{NB} {=}^{( 16 , 21 )} 1 - \frac{1}{1 + {\sum }_{θ ∈ Θ \backslash \{ θ° \}} exp \{ - {\tilde{λ}}_{k , ∞} ( θ ) \}} {=}^{( 16 ) ( 21 ) ( 40 )} 1 - \frac{1}{1 + {\sum }_{θ ∈ Θ \backslash \{ θ° \}} \frac{{μ}_{m} ( θ )}{{μ}_{m} ( θ° )} exp \{ - {[ ( {( I - {R}^{T} )}^{- 1} - I ) {d}_{- m} ( θ ) ]}_{k} \}} . \qquad ( 70 )$$

Here, setting μₘ(θ)=1/H for any θ∈Θ based on (69) yields:

$${\overline{C}}_{m \to k}^{NB} = 1 - \frac{1}{1 + {\sum }_{θ ∈ Θ \backslash \{ θ° \}} exp \{ - {[ ( {( I - {R}^{T} )}^{- 1} - I ) {d}_{- m} ( θ ) ]}_{k} \}} . \qquad ( 71 )$$

Since all KL divergences are assumed to be finite (dₖ(θ)<∞) and the strongly connected graph assumption in Sec. 3 implies ρ(R)<1,

$${‖ ( {( I - {R}^{T} )}^{- 1} - I ) {d}_{- m} ( θ ) ‖}_{∞} < ∞ . \qquad ( 72 )$$

Incorporating this into (71) implies that

$${\overline{C}}_{m \to k}^{NB} > 0 , ∀ m \neq k .$$

Furthermore, regarding the diagonal elements of C̅, it holds by definition that an intervention on agent m implies:

$${\tilde{λ}}_{m , ∞} ( θ ) = log \frac{{μ}_{m} ( θ° )}{{μ}_{m} ( θ )} \qquad ( 73 )$$

As a result, if set μₘ(θ)=1/H, ∀θ∈Θ

$${\overline{C}}_{m \to m}^{NB} {=}^{( 16 ) , ( 21 )} 1 - \frac{1}{1 + {\sum }_{θ ∈ Θ \backslash \{ θ° \}} exp \{ - {\tilde{λ}}_{m , ∞} ( θ ) \}} = 1 - \frac{1}{1 + {\sum }_{θ ∈ Θ \backslash \{ θ° \}} exp \{ 0 \}} = 1 - \frac{1}{H} > 0 \qquad ( 74 )$$

Consequently, all entries of C̅ are positive, which implies that C̅ is a primitive matrix. Therefore, according to Perron's theorem, C̅ has a unique, real and positive eigenvalue ρ that dominates all other eigenvalues in magnitude. Moreover, the eigenvector q corresponding to ρ is unique up to a scaling and all its entries are positive, that is:

$$\overline{C} q = ρ q , {q}_{k} > 0 , ∀ k = 1 , ... , K . \qquad ( 75 )$$

The entry qₖ is a measure of agent k's overall influence over the network. The agents can be ranked with respect to these entries. The resulting ranking method is denoted as the CausalRank method 800 and is depicted in FIG. 8. Thus, in various embodiments causal ranking may be performed substantially in accordance with (75), which computes a causal eigenvector centrality that attributes higher importance to exerting influence on agents who are themselves influential.

Importantly, the vector q—which is the output of the CausalRank method—differs from the network centrality eigenvector v in general. While v is determined solely by the combination matrix A (see (2)), as shown in previous sections, causal influences and hence q depend on the informativeness of agents as well. Pseudocode for the CausalRank method is as follows:

```
Input: a network of K agents with indices {1, 2, ... , K}, combination matrix A, set Θ of H
hypotheses, informativeness vector d(θ)
Initialize: K × K-dimensional influence matrix C̅
For each agent m = 1, 2, ... , K do
  for each agent k = 1, 2, ... , K do
    if m = k then
        $set {[ \overline{C} ]}_{mm} : = 1 - \frac{1}{H}$
    else
      compute the causal effect C̅_{m→k} with (71)
      set [C̅]ₘₖ: = C̅_{m→k}
    end if
  end for
end for
find the largest eigenvalue ρ of C̅
Output: the eigenvector q satisfying C̅q = ρq
```

### CausalRank Method

As noted above, (75) computes a causal eigenvector centrality that attributes higher importance to exerting influence on agents who are themselves influential. Various embodiments instead use an approach denoted as average influence ranking (AIR) in which all agents are treated with equal regard in the averaging process by assigning the following ranking score to each agent m:

$$AIR ( m ) = \frac{1}{K - 1} {\sum }_{k \neq m} {\overline{C}}_{m \to k} \qquad ( 76 )$$

In contrast, rather than employing a simple averaging, CausalRank seeks the equilibrium vector by assigning significant weights to those agents that have a higher influence on other influential agents. This concept bears resemblance to other methodologies based on eigenvector centrality, such as the PageRank algorithm. While ranking websites, PageRank gives preferential treatment to links from more central websites.

It is also worth mentioning that CausalRank is distinct from the causal ordering methods for directed acyclic graphical models since dealing with cyclic graphs with bidirectional links due to the time-series setting. Furthermore, CausalRank is not only useful for ranking, but also provides information on the strength of agents' overall influence on others.

### 7 Causal Discovery from Observational Data

Section 5 derived the closed-form expressions (40) and (61) for the steady-state equilibrium of the network under interventions, which necessitate knowledge of the combination matrix A and the informativeness of agents d(θ). In practice, these parameters might not be readily available. The Graph Social Learning (GSL) algorithm or method can be used to recover A and d(θ) using a sequence of publicly shared intermediate beliefs (a.k.a. actions) {ψ_{k,i}} in the observational setting of the ASL algorithm. Using observational data only can be especially useful in social network contexts where conducting experiments is not feasible. Nonetheless, acknowledge that the algorithm may not perform well in real-world scenarios, mainly due to the limitations of the social learning model in accurately describing the real world. However, in many applications, some information about the underlying combination matrix A may already be available. For instance, in Twitter, the publicly available adjacency matrix can provide information about which user follows which other users.

In the following, an algorithmic method is disclosed that leverages this adjacency matrix and the publicly shared intermediate beliefs {ψ_{k,i}} to estimate bipartite causal effects for both NBSL and ASL algorithms. To that end, observe that the intermediate log-belief ratios evolve based on a linear recursion due to (10):

$${Λ}_{i} = ( 1 - δ ) {A}^{T} {Λ}_{i - 1} + β {X}_{i} \qquad ( 77 )$$

where we are now defining the following K×H matrices over all agents k∈{1, . . . , K} and hypotheses θⱼ∈Θ:

$${[ {Λ}_{i} ]}_{kj} {=}^{Δ} log \frac{{ψ}_{k , i} ( \hat{θ} ° )}{{ψ}_{k , i} ( {θ}_{j} )} , {[ {X}_{i} ]}_{kj} {=}^{Δ} log \frac{{L}_{k} ( {ξ}_{k , i} \vert \hat{θ} ° )}{{L}_{k} ( {ξ}_{k , i} \vert {θ}_{j} )} . \qquad ( 78 )$$

Here, \hat{Θ}° is an estimate for the latent state of nature θ° computed as follows after some time M:

$$\hat{θ} ° {=}^{Δ} arg {max}_{θ ∈ Θ} {\sum }_{k = 1}^{K} {ψ}_{k , M} ( θ ) . \qquad ( 79 )$$

The rationale behind (79) is that under proper assumptions it is known from Theorems 1 and 2 that agents learn the true hypothesis with more confidence as M grows. One goal is to infer the true combination matrix A and informativeness vector d(θ) for each hypothesis from a sequence of M+1 matrices {Λ_{M}, Λ_{M-1}, . . . , Λ₀} and the adjacency matrix of the agents.

Estimate A by using existing procedures in the literature for forming combination matrices from adjacency matrices, e.g., by using the averaging or Metropolis rules. For instance, the averaging rule assigns the same weight to all neighbors of an agent, i.e.,

$${[ \hat{A} ]}_{ℓ k} = \frac{1}{\vert {𝒩}_{k} \vert} , if there is a link from ℓ to k ( i . e . , ℓ ∈ {𝒩}_{k} ) \qquad ( 80 )$$

$$0 , otherwise$$

After forming the combination matrix estimate Â, insert it into (77) and average over available M samples to estimate the average log-likelihood ratios that correspond to the informativeness of agents using:

$$\hat{D} = \frac{1}{β M} {\sum }_{i = 1}^{M} ( {Λ}_{i} - ( 1 - δ ) {\hat{A}}^{T} {Λ}_{i - 1} ) . \qquad ( 81 )$$

Then, replace A and dₖ(θⱼ) with Â and [\hat{D}]ₖⱼ in Sec. 5 to obtain the causal effect estimate Ĉ_{m→k}. The complete procedure is summarized below with respect to the Graph Causality Learning (GCL) algorithmic method of FIG. 9. This embodiment of the procedure combines the causality results in Sec. 5 with an adjustment to the GSL method.

FIG. 9 illustrates a GraphCausalityLearning (GCL) method according to an embodiment.

### Graph Causality Learning (GCL)

Input: a sequence of shared beliefs {ψ_{k,i}} for M + 1 time instants, the graph topology of
agents
Parameters: for NBSL δ = 0, β = 1, for ASL δ ∈ (0,1), β > 0
$set true state of nature estimate : \hat{θ} ° = arg {max}_{θ ∈ Θ} {\sum }_{k = 1}^{K} {ψ}_{k , M} ( θ )$
form left-stochastic combination matrix estimate Â from input adjacency matrix, e.g., by
(80)
for i = 0,1, ... , M do
for each agent k and hypothesis θⱼ, set the entry:
${[ {Λ}_{i} ]}_{kj} = log \frac{{ψ}_{k , i} ( \hat{θ} ° )}{{ψ}_{k , i} ( {θ}_{j} )} \qquad ( 82 )$
end for
estimate the informativeness:
$\hat{D} = \frac{1}{β M} {\sum }_{i = 1}^{M} ( {Λ}_{i} - ( 1 - δ ) {\hat{A}}^{T} {Λ}_{i - 1} ) \qquad ( 83 )$
for any given agent pair (m, k), compute approximate causal effect Ĉ_{m→k} by replacing A
and dₖ (θⱼ) with Â and [\hat{D}]ₖⱼ in the original expression (15) for C_{m→k} (which also
requires using (40) for NBSL and (61) for ASL)
Output: Ĉ_{m→k}

The graph causality learning (GCL) method of FIG. 9 only requires a sequence of shared intermediate beliefs (actions) and the knowledge of adjacency matrix. This enhances its practicality and makes it advantageous in terms of privacy for scenarios where only limited information is publicly accessible. For example, in a network of Twitter users, shared beliefs (opinions) in the form of tweets (posts) and the knowledge of who follows whom can usually be accessed by all users, while the external exposure to information (e.g., from mass media channels distinct from Twitter) may not be available. Therefore, the GCL method can be useful for analyzing social media content while respecting privacy. In the next result, provided is a performance bound on the GCL method.

Theorem 3: Causal influence estimation. For sufficiently small combination matrix estimation errors and 8 values, the error in causal influence estimation decreases with increasing number of samples M in expectation, namely,

$$𝔼 \vert {C}_{m \to k} - {\hat{C}}_{m \to k} \vert = O ( 1 / M ) \qquad ( 84 )$$

for both NBSL and ASL under any intervention strength m.

The practical usefulness of the GCL method is demonstrated by means of a real-world application to Twitter data in Sec. 9.

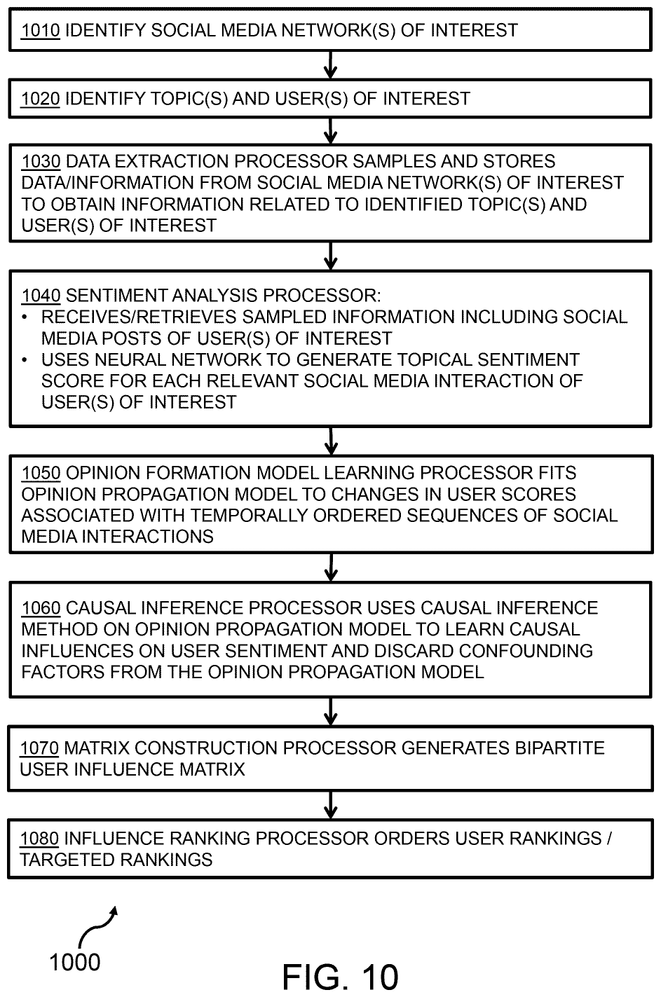

FIG. 10 depicts a flow diagram of a method according to various embodiments suitable for use with the system of FIG. 1. Specifically, FIG. 10 depicts a method 1000 by which the system 105 of FIG. 1 may be used in accordance with various embodiments.

At step 1010, social media networks/platforms of interest are identified.

At step 1020, topic(s) and user(s) of interest are identified.

At step 1030, the data extraction processor is configured to sample data/information from one or more social networks in accordance with desired topics, users, trends, information types, and so on.

At step 1040, the sentiment analysis processor is configured to receive sampled information from the data extraction processor, the received sampled information including social media interactions (e.g., posts of interest) associated with each of a plurality of users, and to determine, using sentiment quantification mechanism (such as a neural network, another machine learning model, or other hardware/software configured to quantify/score opinion or sentiment), for each of at least a portion of the social medial interactions of the plurality of users, a respective sentiment score indicative of user sentiment associated with a topic of interest at a time of social media interaction.

At step 1050, the opinion formation model learning processor is configured to fit an opinion propagation model to changes in user sentiment scores associated with temporally ordered sequences of social media interactions. In addition to the methods described above, various embodiments may use sentiment analysis method such as rule based methods (e.g., how many times a word is used, etc.), other machine learning models, and/or a hybrid approach that includes both rules based method and machine learning models. In some embodiments, annotations from various sources may be incorporated into the sentiment analysis method, such as collaborative or crow-sourced annotations scraped or retrieved from various sources (e.g., services such as Amazon Mechanical Turk).

At step 1060, the causal inference processor is configured to use causal inference methods on the opinion propagation model to learn causal influences on user sentiment and, as a byproduct of such methods, to discard (possibly hidden) confounding factors from the opinion propagation model. Such confounding factors can create spurious relationships between user sentiment and apparent but disconnected causal influence sources.

At step 1070, the matrix construction processor is configured to generate a bipartite user influence matrix.

At optional step 1080 the influence ranking processor is used to order the user rankings in a desired manner (optionally targeted rankings). That is, various embodiments contemplate that the influence ranking processor is further configured to assign importance indicative weights to targeted users or user groups. Targeted users may comprise identifiable or specific users of higher importance based on some level of achievement, or job title, or wealth, or other factor sufficient to specifically identify that user individually. Targeted user groups may comprise user groups or cohorts of higher importance based on demographic information such as age, location, organization membership, voting patterns, cultural associations, self-identification, and so on where demographic or group affiliation is of particular interest or is more highly correlated to such interest (e.g., Finding Users who are influential on age group 30-40 in French speaking Switzerland).

### 8 Computer Simulations

For numerical simulations, studying a network of K=11 agents, interconnected with the graph topology of the strongly connected network architecture depicted in FIG. 11. The agents observe data drawn from a Gaussian distribution and aim to distinguish the true state θ° from H=2 possible hypotheses. Under the true state, each agent k observes data that follows a Gaussian distribution with zero mean and unit variance, expressed as:

$${L}_{k} ( ξ \vert θ° ) = \frac{1}{\sqrt{2 π}} exp \{ - \frac{1}{2} {ξ}^{2} \} . \qquad ( 85 )$$

Under the alternative hypothesis θ′≠θ°, assume that the data still has unit variance for all agents, but the mean vector vₖ changes as shown in Table 1. That is, Table 1 depicts mean vₖ of the observations under alternative hypothesis and the corresponding informativeness levels dₖ(θ′) for each agent k. Therefore, the informativeness of each agent, which is equal to the KL divergence between Lₖ(ξ|θ°) and Lₖ(ξ|θ′), is given in Table 1 and is calculated as follows:

$${d}_{k} ( {θ}^{′} ) = {D}_{KL} ( {L}_{k} ( ξ \vert θ° ) ‖ {L}_{k} ( ξ \vert {θ}^{′} ) ) = \frac{1}{2} {v}_{k}^{2} . \qquad ( 86 )$$

TABLE 1

| Agent | vₖ | dₖ (θ′) |
|---|---|---|
| 1 | 0.8 | 0.32 |
| 2 | 0.6 | 0.18 |
| 3 | 0.2 | 0.02 |
| 4 | 0.6 | 0.18 |
| 5 | 0 | 0 |
| 6 | 0 | 0 |
| 7 | 0.4 | 0.08 |
| 8 | 0.4 | 0.08 |
| 9 | 0.2 | 0.02 |
| 10 | 0.6 | 0.18 |
| 11 | 0.8 | 0.32 |

Notably, agents 5 and 6 have no informativeness, that is, they are not able to learn the truth without cooperating with the other agents. Initially, assume that the agents observe spatially independent data. In other words, the covariance matrix is an identity matrix.

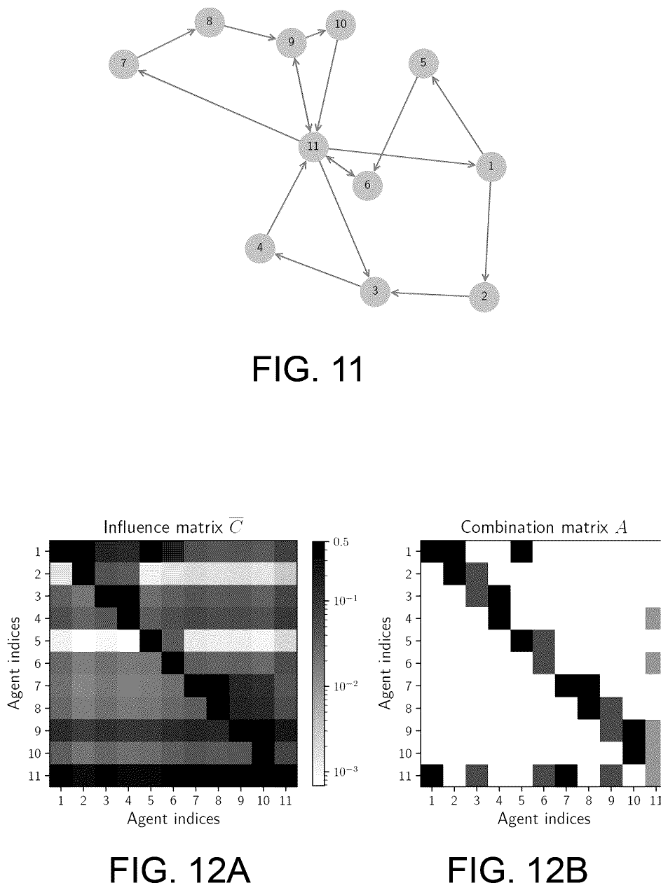

Starting with the NBSL case (δ=0,β=1). FIG. 12B shows the combination matrix that is derived from the averaging rule applied to the graph topology in FIG. 11. Notice that the averaging rule generates a matrix whose entries are constant column-wise. FIG. 12A shows the matrix of bipartite causal effects where the entry in m-th row k-th column represents

$${\overline{C}}_{m \to k}^{NB}$$

(see (71) for the explicit formula).

Upon comparing the two heat maps in FIGS. 12A-12B, it becomes apparent that the combination matrix entries do not reveal the causal relationships directly. For example, despite the absence of a direct connection in the combination matrix (as indicated by 0 entries), agent 11 exerts significant influence on agents 2 and 8. This phenomenon highlights the importance of taking the ripple effects over a network into account. Furthermore, the influence of agent 1 on agent 5 is notably high. Given the zero informativeness of agent 5, this finding aligns with inventors' expectations, as low-informativeness agents are easier to control (remember the discussion in Sec. 5.1). Agent 5 being a low-informativeness agent also facilitates the propagation of influence from agent 1 to agent 6 via agent 5. Intriguingly, despite the absence of a direct connection between agents 1 and 6, this indirect influence is more substantial than the influence of agent 5 on agent 6. This shows that mixing of information over a network necessitates an understanding of causal influence beyond local interactions.

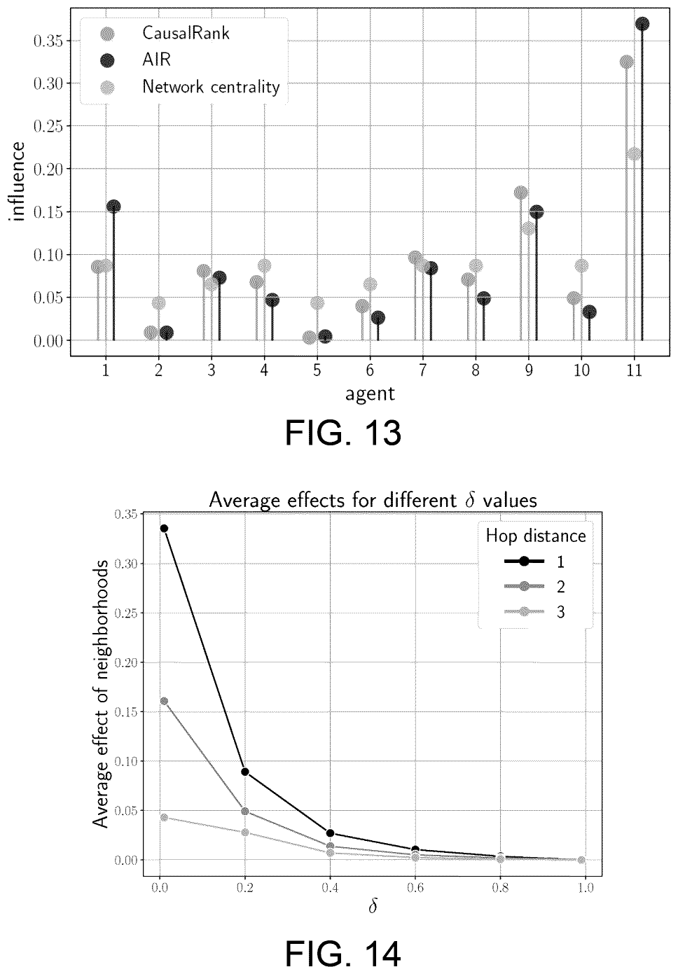

FIG. 13 illustrates a ranking of agents based on their causal influence (for both CausalRank and AIR) and their network-topology based eigenvector centrality. All ranking scores are normalized to sum up to one. Specifically, using the matrices in FIGS. 12A-12B, a comparison is made and illustrated of the overall influences of agents using three methods; namely, CausalRank, AIR, and network eigenvector centrality. Notably, the CausalRank and AIR metrics yield similar results as they both use the bipartite causal relations matrix for causal ranking. For instance, agents 2 and 5 possess relatively low rankings in both of these metrics. The network eigenvector centrality, on the other hand, only relies on the combination matrix, and often deviates from these two metrics. Specifically, it assigns relatively higher scores to agents 2 and 5, and a comparatively lower score to agent 11. Moreover, an interesting distinction between AIR and CausalRank becomes apparent when considering the case of agent 9. It can be seen from the causal influence matrix in FIG. 12A that agent 9 has a substantial impact on agent 11 the most influential agent (see FIG. 11). Consequently, agent 9's CausalRank score surpasses its AIR score. This can be attributed to CausalRank's consideration of the significance of influencing agent 11. Unlike AIR, which assigns uniform weights, CausalRank assigns a higher weight to influences on more influential agents.

To gain insights into the influence of the forgetting factor δ in the ASL case, focus on agent k=4. FIG. 14 presented the average influence exerted by agent 4's neighbors that are 1, 2, and 3 hops away. It is clear from FIG. 14 that the influence of distant agents diminishes with increasing δ. This is because increasing δ increases the significance of recent observations, and since information from distant agents loses its recency by the time it arrives at agent 4, this implies assigning less importance to information from those distant agents.

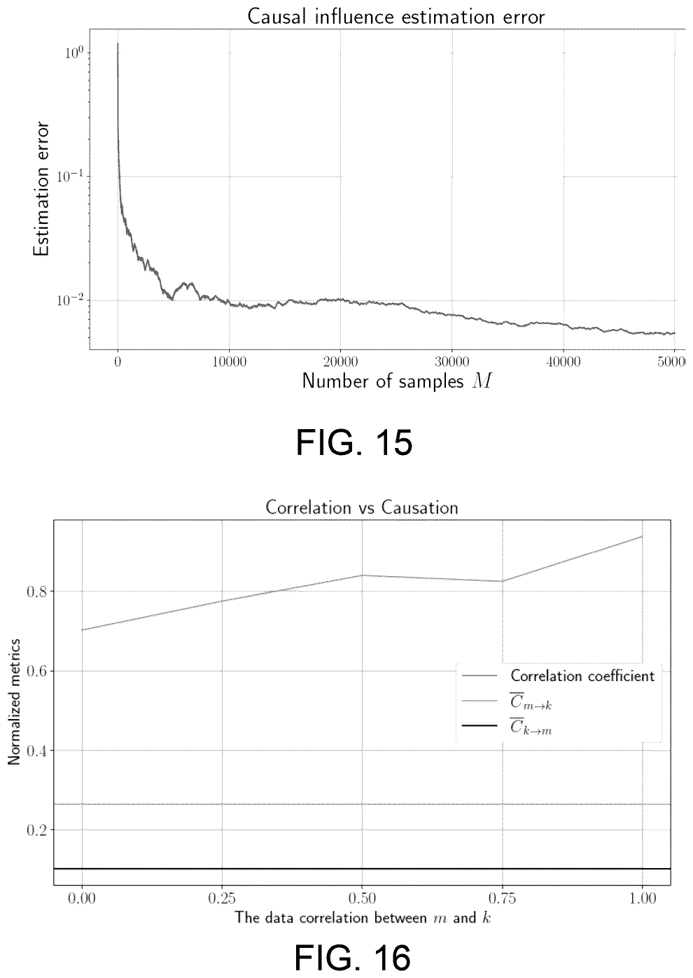

Fix δ=0.1, and use the GCL algorithmic method (FIG. 9) in order to estimate the causal effects using observational data (shared beliefs) as described in Sec. 7. The norm disagreement of the causal influence matrix formed with estimates and the true causal influences, averaged over 10 Monte Carlo simulations, is given in FIG. 15. Observe that the error is decreasing as the number of samples M increases, which supports Theorem 3.

Finally, illustrate the distinction between causality and correlation. Choose agents 11 and 6 for this purpose. The joint distribution of their data is changed by introducing varying levels of correlation to the observations that these agents are receiving. FIG. 16 shows that as the correlation in data increases, the correlation of the asymptotic beliefs of these agents also changes. However, the causal effects (both the effect of agent 6 on 11 and that of agent 11 on 6) remain constant. This shows that external observations can act as a correlation inducing confounding factor. Yet, the method maintains consistent results, which shows its robustness against non-causal factors.

FIG. 14 illustrates an average influence on agent k=4 from its neighborhood of 1,2 and 3 hop distances with respect to changing values of forgetting factor S. FIG. 15 illustrates causal influence estimation error with respect to increasing number of time samples M. FIG. 16 illustrates correlation and causation between agents 6 and 11 of the network of FIG. 11 with respect to varying dependence between the streaming observations they receive.

### 9 Application to Twitter Data

This section uses the GCL algorithmic method 2 (Algorithm 2 of FIG. 9) on real-world data to assess the influence of Twitter users. The approach distinguishes itself from prior works, which typically rely on some descriptive statistics to measure influence in Twitter. More specifically, in the disclosed methodology,
All input requirements are publicly available, i.e., publicly shared posts (tweets) by users and the information of who follows whom. This offers a significant advantage in terms of privacy, as it does not require any private feature about users.
Going beyond providing a mere ranking of influential users, the inventors also quantify the bipartite causal relations.
the inventors leverage natural language processing tools to extract meaningful information from the content of users' posts to form belief inputs, rather than relying on traditional simpler metrics such as the posting frequency.

User sentiment with respect to a posting, story, or other data may be indicated by direct affirmation, such as user selection of a like, dislike, sentiment indicative emoji, or other predefined sentiment indicator. User sentiment with respect to a presented posting, story, or other data may be indicated by symbolic affirmation, such as user text indicative of positive or negative sentiment, the user text may also include text based sentiment indicative emojis and the like (e.g., smiley face, sad face, thumbs-up, thumbs-down, selecting range of satisfaction such as numeric 1-10 or a number of graphically presented “stars” and so on). User sentiment, whether via direct affirmation or symbolic affirmation, may be weighted in terms of strength such as by interpreting positive or negative sentiment affirmation in terms the strength of that affirmation (e.g., agree/disagree, strongly agree/disagree, or very strongly agree/disagree, as indicated via user text or selection of sentiment indicator or choice of emoji, etc.).

Note that algorithmic method 2 for the NBSL model (δ=0,β=1) is uses as-is, without employing additional techniques to enhance its accuracy for real-world modeling. The intention is to demonstrate the practical usefulness of the algorithm rather than striving to develop the most advanced practical algorithm available.

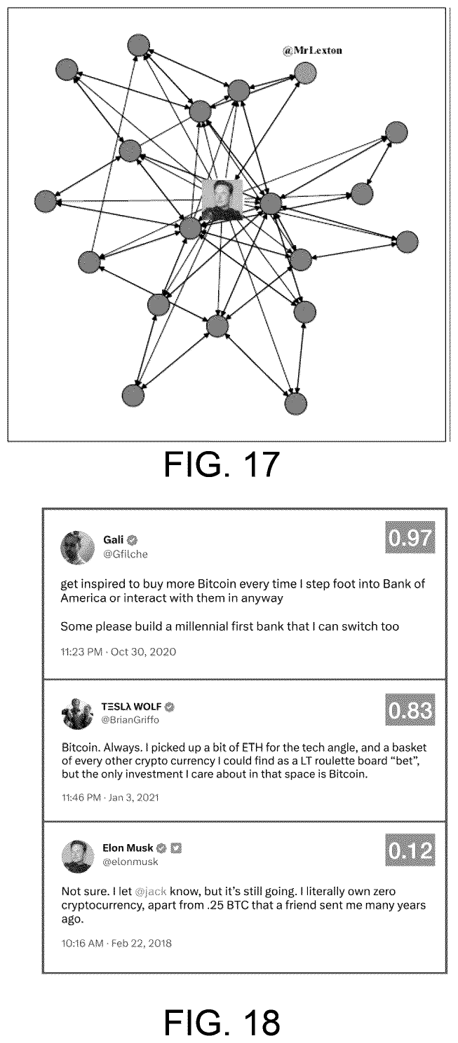

Network structure. Performance evaluation of the influence estimation algorithms in real-world social networks is challenging due to the absence of ground truth regarding influential users. There is also no ground truth reference for the confidence scores assigned by users to one another (i.e., combination weights) or for the information the users are obtaining from out-of-network resources (i.e., informativeness levels). Therefore, utilizing a sub-network consisting of K=20 Twitter users, as illustrated in FIG. 17. Notably, this sub-network incorporates Elon Musk, a public figure with 140 million followers across Twitter, who is reportedly influential on cryptocurrency prices. All users within the sub-network actively share posts related to cryptocurrencies and bitcoin-related topics. Furthermore, one user, with username @MrLexton, who has 1,167 followers across Twitter, is notable for being followed by Elon Musk, as depicted in FIG. 17. Importantly, the sub-network exhibits a strong connectivity among its members.

Opinion processing. The Twitter API is leveraged in order to collect the posts (tweets) of users between 01.01.2017 and 01.05.2022 relevant to crypto-currency discussions, using query keywords such as “coin”, “bitcoin”, or “crypto-currency”. To quantify the contextual information of these posts to form the input beliefs, sentiment analysis based on neural language models is utilized. Some illustrative examples are provided herein, such as a table of tweet (X-postings) as discussed below with respect to FIG. 18. The sentiment scores obtained through natural language processing ranges from 0 to 1, signifying the degree of positive attitude towards Bitcoin. These scores correspond to the beliefs of the agents on the hypothesis of “Bitcoin is good/useful”. Consider two hypotheses, i.e., H=2, where the counter-hypothesis is “Bitcoin is bad/harmful”.

Integrate these beliefs obtained from users' tweets, along with the sub-network topology of who follows whom, into algorithmic method 2; specifically, employing NBSL modeling, i.e., δ=0 and β=1. Combination weights were estimated using an averaging rule on the sub-network topology.

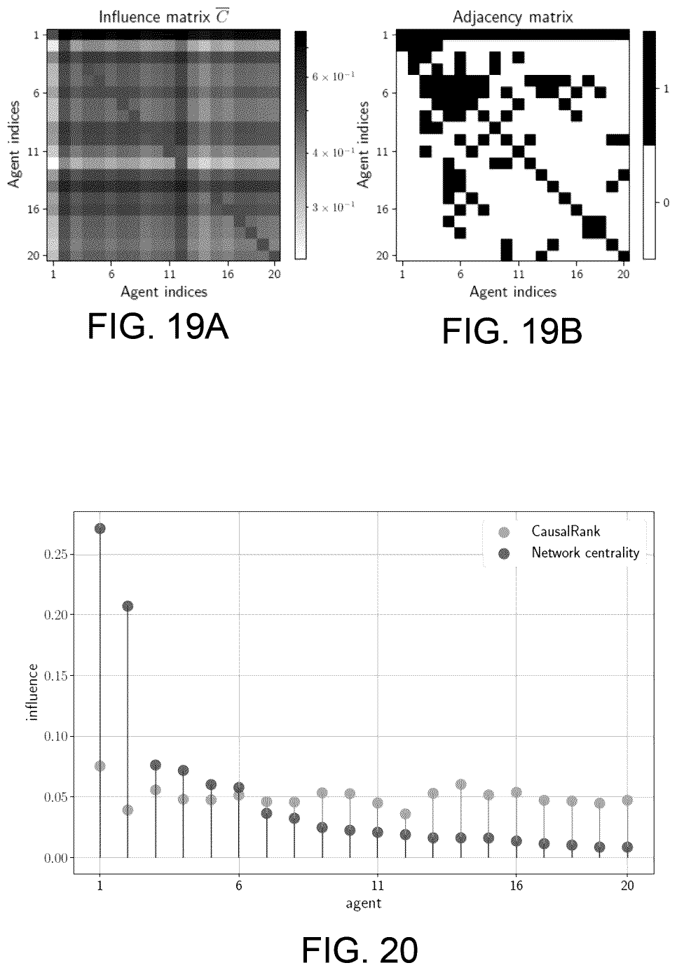

FIG. 18 illustrates sample tweets from the users in the sub-network topology of FIG. 17. The number on the upper right hand side quantifies the positive attitude towards Bitcoin. FIG. 19A-19B illustrate, respectively, a bipartite causal influence matrix and an adjacency matrix corresponding to the sub-network topology of FIG. 17. FIG. 20 illustrates ranking of agents based on their causal influence and their corresponding network eigenvector centrality, wherein both ranking scores are summing up to one.

Bipartite causality. Inserting the observational input into algorithm 2, the resulting average causal derivative effect matrix is shown in FIGS. 19A-19B in the form of a heat map. To facilitate comparison, include the adjacency matrix, which describes the connections between users. In these plots, the indices 1 and 2 correspond to specific users: Elon Musk (User 1) and @MrLexton (User 2), respectively.

Upon observing the heat map, it is evident that Elon Musk holds significant influence over all other users, as indicated by the high values in the 1st row, which aligns with inventors' expectations. However, notice that the adjacency matrix does not precisely mirror the causal relationships. For instance, User 2 is followed by Elon Musk, yet their influence on Elon Musk, as depicted in the heat map, is relatively low. On the other hand, User 14 exerts a substantial impact on User 2, despite not being directly followed by User 2. This fact may arise from the fact that User 14 holds one of the highest influences on Elon Musk (User 1) among all the users in this particular sub-network. These observations highlight the fact that the nature of influence dynamics within real-world social networks cannot simply be explained with direct follower relations.

Causal impact ranking. Once the influence matrix is determined, apply the CausalRank algorithmic method (Algorithm 1 of FIG. 8) to rank the agents based on their overall influence within the sub-network. The resulting plot is depicted in FIG. 20. Notably, Elon Musk emerges as the most influential agent, aligning with inventors' initial expectations.

However, an intriguing observation can be made regarding User 2. Despite having a high eigenvector centrality, their causal impact score appears relatively small. This phenomenon arises because the causal effect is not solely determined by network centrality but also takes into account the informativeness of the agents. For instance, if a user primarily retweets (reposts) what their neighbors are tweeting, such users tend to possess low informativeness, decreasing their causal impact score. Thus, even though User 2 may have a high centrality within the considered sub-network primarily due to being followed by Elon Musk, their causal influence on their neighbors is low and does not propagate to other users, leading to a relatively small causal impact.

### 10 Conclusion

Discussed above is analysis of causal influences among agents that are connected over a network and whose interactions occur over time. Using social learning models, expressions are derived for the causal relationships between pairs of agents. These expressions offer key insights into the diffusion of influences across a social network. Also proposed is the CausalRank algorithm for ranking the overall influence of agents, which allows discovering highly influential actors within a network. Furthermore, to enhance the practical usage of the results, proposed is the graph causality learning algorithm (GCL) that learns the necessary model parameters from raw observational data in order to estimate the causal effects. This demonstrates how GCL can be applied in practice through an application to real Twitter data.

The social learning models considered in this work are useful for both modeling opinion formation over social networks as well as for designing distributed decision-making systems. Therefore, potential applications range from the analysis of human social networks, such as those on social media platforms, to cooperative decision-making processes of socially intelligent machines like networks of drones or sensors. In addition to these, the results can be useful for applications that involve time-series networked interactions, since they provide insights on the diffusion of influence across graphs.

In practice, the social learning models considered might not fully encapsulate real-world conditions. Therefore, a possible future direction could be to blend these models with data-driven approaches, as in model-based deep learning. In this manner, not only can the results be used on these models for causal explainability, but they also enhance the capacity of the disclosed models to mirror real-world conditions. Doing so can achieve a balance between interpretability and performance that results in a more trustworthy and transparent approach, as opposed to fully data-driven approaches with “black-box” models.

It will be appreciated that the functions depicted and described herein may be implemented in hardware or in a combination of software and hardware, e.g., using a general purpose computer, one or more application specific integrated circuits (ASIC), or any other hardware equivalents. It will be appreciated that GM 120, various embodiments of local devices 130, as well as other devices described herein are generally depicted as general purpose computing devices having a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A system for detection and quantification of influence, the system comprising:
a data extraction processor configured to sample data from one or more social networks;
a sentiment analysis processor configured to:
receive sampled data from the data extraction processor, the received sampled data including social media interactions associated with each of a plurality of users; and
determine, via a sentiment quantification mechanism, for each of at least a portion of the social medial interactions of the plurality of users, a respective sentiment score indicative of user sentiment associated with a topic of interest at a time of social media interaction;
an opinion formation model learning processor configured to fit an opinion propagation model to changes in user sentiment scores associated with temporally ordered sequences of social media interactions;
a causal inference processor configured to determine causal influences associated with changes in user sentiment scores of the opinion propagation model; and
a multidimensional array construction processor configured to generate a bipartite user influence matrix.

2. The system of claim 1, wherein the sentiment quantification mechanism is implemented via a neural network.

3. The system of claim 1, wherein determining causal influences includes discarding confounding factors associated with changes in user sentiment scores of the opinion propagation model.

4. The system of claim 1, wherein user social media interactions comprising user postings.

5. The system of claim 4, wherein user postings comprise one or more of direct messages, indicia of sentiment, and symbolic indicia of sentiment.

6. The system of claim 4, wherein user postings are further weighted to indicate respective sentiment strength.

7. The method of claim 1, wherein the bipartite user influence matrix comprises a K×K matrix.

8. The method of claim 1, further comprising:
an influence ranking processor configured to order influential users by rank for each of at least one topic of interest.

9. The method of claim 8, wherein ranking is performed in accordance with average influence ranking.

10. The method of claim 9, wherein average influence ranking is performed in accordance with the following equation:
$$AIR ( m ) = \frac{1}{K - 1} {\sum }_{k \neq m} {\overline{C}}_{m \to k}$$

11. The method of claim 8, wherein ranking is performed in accordance with causal ranking.

12. The method of claim 11, wherein causal ranking is performed in accordance with the following equation:
$$\overline{C} q = ρ q , {q}_{k} > 0 , ∀ k = 1 , ... , K .$$

13. The method of claim 8, wherein the influence ranking processor is further configured to assign importance indicative weights to targeted users or user groups.

14. The method of claim 1, wherein the user postings are processed via a neural network to quantify user topical sentiment at posting times.

15. An apparatus, comprising processing resources and non-transitory memory resources, the processing resources configured to execute software instructions stored in the non-transitory memory resources to provide thereby a method of detection and quantification of influence, the apparatus configured for communicating with one or more social networks, the method comprising:
sampling data from one or more social networks to obtain therefrom information including social media interactions associated with each of a plurality of users;
determining, using a sentiment quantification mechanism, for each of at least a portion of the social medial interactions of the plurality of users, a respective sentiment score indicative of user sentiment associated with a topic of interest at a time of social media interaction;
fitting an opinion propagation model to changes in user sentiment scores associated with temporally ordered sequences of social media interactions;
determining causal influences associated with changes in user sentiment scores of the opinion propagation model; and
generating a bipartite user influence matrix.

16. The apparatus of claim 15, wherein the sentiment quantification mechanism is implemented via a neural network.

17. The apparatus of claim 15, wherein determining causal influences includes discarding confounding factors associated with changes in user sentiment scores of the opinion propagation model.

18. The apparatus of claim 15, wherein user social media interactions comprising user postings of one or more of direct messages, indicia of sentiment, and symbolic indicia of sentiment.

19. The apparatus of claim 15, further comprising:
an influence ranking processor configured to order influential users by rank for each of at least one topic of interest in accordance with one of average influence ranking and causal ranking.

20. The apparatus of claim 19, wherein the influence ranking processor is further configured to assign importance indicative weights to targeted users or user groups.
